(19) United States
(12) Patent Application Publication
(10) Pub. No.: US 2023/0068939 A1
(43) Pub. Date: Mar. 2, 2023

(54) SYSTEM AND METHOD FOR SEMI-FOAM FLEXIBLE SEALANT WITH DENSITY MODIFIER

(71) Applicant: Polymer Adhesive Sealant Systems, Inc., Mineral Wells, TX (US)

(72) Inventors: Sandra Kocurek, Crowley, TX (US); Devin Kocurek, Crowley, TX (US)

(73) Assignee: Polymer Adhesive Sealant Systems, Inc., Mineral Wells, TX (US)

(21) Appl. No.: 17/890,035

(22) Filed: Aug. 17, 2022

Related U.S. Application Data
(60) Provisional application No. 63/234,698, filed on Aug. 18, 2021.

(51) Int. Cl. C09J 125/08; C09J 133/08; C09J 133/20

(52) U.S. Cl. CPC C09J 125/08; C09J 133/08; C09J 133/20; C09J 2301/408; C09J 2301/412

(57) ABSTRACT

An elastomeric mastic sealant composition and method of manufacturing are disclosed. In certain embodiments, the composition may include between about 13 and about 19 weight percent or between about 11 and about 15 volume percent of acrylate-acrylonitrile copolymer. The composition may further comprise one or more of between about 36 and about 41 weight percent or between about 29 and about 34 volume percent of styrenated acrylic polymer; between about 1 and about 2 weight percent or between about 0.9 and about 1.7 volume percent of surfactant; between about 0.6 and about 1.4 weight percent or between about 0.4 and about 1 volume percent of dispersant; and between about 0.4 and about 1 weight percent or between about 29 and about 40 volume percent of pre-expanded compressible microspheres having an organic outer surface and introduced by a closed mixing system into the copolymer. In some implementations, the disclosed composition and method forms a closed-cell, semi-foam, mastic sealant using gas-filled, flexible, organic microspheres to create a product that once cured, is elastic and compressible under pressure without unduly protruding in an outward direction when compressed, thereby allowing the applied sealant to compress in an enclosed, maximum-filled channel unlike typical mastic sealants (while retaining the ability to rebound). This allows the sealant in such implementations to function as a gasket, and to have properties including vibration damping, insulating, and/or condensation resistance.

### PRIOR RELATED APPLICATIONS

This application claims benefit of U.S. Provisional Patent Application No. 63/234,698, entitled “IMPROVED SYSTEM AND METHOD FOR SEMI-FOAM FLEXIBLE SEALANT WITH DENSITY MODIFIER,” filed on Aug. 18, 2021, the entire contents of which is incorporated by reference, for any and all purposes.

### FIELD OF INVENTION

The present disclosure relates generally to sealant compounds. More specifically, but not by way of limitation, the present disclosure relates to a system and method for a semi-foam flexible sealant with a density modifier and optional flame resistance.

### BACKGROUND OF INVENTION

The statements in this section merely provide background information related to the present disclosure and may not constitute prior art.

Conventional sealants do not contain sufficient structural properties for all desired uses or methods of application. For example, when cured, typical one-component mastic sealants are limited in compressibility and tend to deform in a direction outward from the bead line in which they are applied. Typical mastic sealants are also too rigid to create an adequate sealing gasket for building materials such as, for example, gypsum drywall. Although high-movement elastomeric sealants have a higher extension capability, they are unable to compress without protruding in some other direction and, therefore, cannot compress in a closed, maximum-filled chamber (e.g., a can). Additionally, when many spray foams are cured, breaching the skin of the cured foam compromises the foam's integrity, thereby reducing or nullifying the ability of the foam to provide an adequate seal.

Regarding application, two-component spray foams are dependent on off-gassing chemicals such as isocyanates that are known allergens and sensitizers, and other spray foams often utilize highly flammable propellants making them especially undesirable for fire- and smoke-resistant applications. Two-component spray foam systems often require specialized application tools. Such foam systems may result in difficulty in controlling uniformity in cell size and cleaning the application equipment or foam over-spray. As such, there is a desire for other sealant compounds.

### SUMMARY OF INVENTION

Further embodiments and apparatuses, including other areas of applicability, will become apparent from the description provided herein. It should be understood that the description and specific examples are intended for purposes of illustration only and are not intended to limit the scope of the present disclosure in any manner.

An elastomeric mastic sealant composition is provided. The composition may include between about 13 and about 19 weight percent (and any range or value there between) and/or between about 11 and about 15 volume percent (and any range or value there between) of acrylate-acrylonitrile copolymer. The composition may include between about 36 and about 41 weight percent (and any range or value there between) and/or between about 29 and about 34 volume percent (and any range or value there between) of styrenated acrylic polymer. The composition may include between about 1 and about 2 weight percent (and any range or value there between) and/or between about 0.9 and about 1.7 volume percent (and any range or value there between) of surfactant. The composition may include between about 0.6 and about 1.4 weight percent (and any range or value there between) and/or between about 0.4 and about 1 volume percent (and any range or value there between) of dispersant. The composition may include between about 0.4 and about 1 weight percent (and any range or value there between) and/or between about 29 and about 40 volume percent (and any range or value there between) of pre-expanded compressible microspheres having an organic outer surface and introduced by a closed mixing system into the copolymer.

In various embodiments of the elastomeric mastic sealant composition, the sealant composition has a density of about 0.82 g/cm³. In various embodiments of the elastomeric mastic sealant composition, the microspheres are selected from a group including Expancel MI 90 DET 80 d15 microspheres and Expancel 909 DET 80 d15 microspheres.

The elastomeric mastic sealant composition may include further components. For example, the elastomeric mastic sealant composition may include between about 3 and about 12 weight percent (and any range or value there between) and/or between about 3 and about 10 volume percent (and any range or value there between) of diluent. The elastomeric mastic sealant composition may include between about 0.04 and about 0.3 weight percent (and any range or value there between) and/or between about 0.04 and about 0.3 volume percent (and any range or value there between) of defoamer. The elastomeric mastic sealant composition may include between about 0.04 and about 0.5 weight percent (and any range or value there between) and/or between about 0.03 and about 0.4 volume percent (and any range or value there between) of a first biocide. The elastomeric mastic sealant composition may include between about 0.7 and about 1.5 weight percent (and any range or value there between) and/or between about 0.6 and about 1.2 volume percent (and any range or value there between) of a freeze/thaw additive. The elastomeric mastic sealant composition may include between about 0.7 and about 4 weight percent (and any range or value there between) and/or between about 0.5 and about 3.2 volume percent (and any range or value there between) of a thickener. The elastomeric mastic sealant composition may include between about 0.3 and about 1.1 weight percent (and any range or value there between) and/or between about 0.2 and about 1 volume percent (and any range or value there between) of a pH modifier. The elastomeric mastic sealant composition may include between about 21 and about 26 weight percent (and any range or value there between) and/or between about 7.3 and about 9.4 volume percent (and any range or value there between) of a first flame retardant.

In various embodiments, a yet further at least between about 0.04 and about 0.5 weight percent (and any range or value there between) and/or between about 0.03 and about 0.4 volume percent (and any range or value there between) of a second biocide is included.

In various embodiments, a yet further at least between about 0 and about 2 weight percent (and any range or value there between) and/or between about 0 and about 0.5 volume percent (and any range or value there between) of functional filler is included. Similarly, at least between about 2 and about 5 weight percent (and any range or value there between) and/or between about 0.6 and about 1.7 volume percent (and any range or value there between) of kaolin clay may be included. Additionally, at least between about 0.07 and about 0.3 weight percent (and any range or value there between) and/or between about 0.09 and about 0.2 volume percent (and any range or value there between) of adhesion promoter may be included.

In various embodiments, the pre-expanded compressible microspheres are introduced into the acrylate-acrylonitrile copolymer. In further embodiments, the pre-expanded compressible microspheres are introduced into the acrylate-acrylonitrile copolymer utilizing a vacuum to facilitate wetting out the microspheres. Alternatively, the pre-expanded compressible microspheres may be introduced by a peristaltic pump of the closed mixing system into the acrylate-acrylonitrile copolymer. Moreover, the pre-expanded compressible microspheres may be introduced by a peristaltic pump of the closed mixing system into the acrylate-acrylonitrile copolymer by pulling a vacuum to facilitate wetting out the microspheres.

The elastomeric mastic sealant composition may have an aqueous uncured state. In various embodiments, the aqueous uncured state of the sealant composition has a first aqueous volume and is capable of being compressed from the first aqueous volume to a second aqueous volume that is less than the first aqueous volume.

A method of manufacturing a sealant composition is provided. The method may include mixing a liquid and additives in a vessel including a mixing apparatus. The method may include activating the mixing apparatus of the vessel to stir the liquid and additives. The method may include activating a vacuum configured to draw a polymeric dispersion into the vessel. The method may also include dosing a polymeric dispersion into the mix of liquid and additives. The method may include dosing the polymeric dispersion into the mix of liquid and additives from a weigh hopper. Moreover, the method may include dosing a density modifier including microspheres into the vessel via a peristaltic pump. The density modifier may be between about 29 and about 40 volume percent (and any range or value there between) of the sealant composition. The method may further include permitting the density modifier to settle onto the polymeric dispersion to clear the density modifier from a headspace of the vessel. The method may contemplate activating the vacuum and activating the mixing apparatus to wet out the density modifier. Finally, the method may include deactivating the vacuum and deactivating the mixing apparatus.

The method may include additional aspects. For instance, the method may include adding a first dry material following the deactivating the mixing apparatus. The method may also include reactivating the mixing apparatus to stir the liquid, additives, density modifier, and/or first dry material.

In various instances of the method, a cured state of the sealant composition is a closed-cell air barrier thermally insulating foam and has a first cured volume and is compressible from the first cured volume to a second cured volume when under a pressure. The cured state of the sealant composition is configured to return to the first cured volume after the pressure is removed. Additionally, an aqueous uncured state of the sealant composition has a first aqueous volume and is capable of being compressed from the first aqueous volume to a second aqueous volume that is less than the first aqueous volume.

In various instances, the method also includes filtering the sealant composition for use in a spray application. The filtering may include drawing the sealant composition through a sieve with a vacuum pump. The filtering may include continuously sweeping the sealant composition through a sieve of a self-cleaning industrial filter system.

The density modifier associated with the method may include microspheres with an outer shell encapsulating a gas. In various instances, the method includes packaging the sealant composition in one or more of aerosol cans, cartridge tubes, foil tubes, squeeze tubes, buckets, or combinations thereof.

The method of manufacturing a sealant composition may include manufacturing the sealant composition to have various properties. For instance, the elastomeric mastic sealant composition may be configured to have one or more of the attributes selected from a group including air blocking, structural reinforcement, moisture resistance, condensation control, thermal resistance, smoke resistance, flame resistance, reduced shrinkage, altered density, changed electro-conductivity, improved scrub resistance, reduced tack, altered optical properties, altered permeability, vibration dampening, acoustical absorption, slump resistance, stain resistance, low temperature flexibility, extension and/or recover, insulating, low density, easy extrudability, easy tooling, and/or easy spray application.

The method of manufacturing a sealant composition may include manufacturing the sealant composition with additives wherein the additives are selected from the group of mica, aluminum trihydrate (ATH), magnesium hydroxide, expandable graphite, ammonium polyphosphate, ammonium phosphate, urea, sodium silicate, and/or combinations thereof.

The density modifiers introduced in the method of manufacturing a sealant composition may be about 33.4 volume percent of the sealant composition.

A method of manufacturing a sealant composition is further provided. The method may include adding styrenated acrylic polymer, acrylate-acrylonitrile copolymer, and/or diluent into a vessel. The method may include activating a mixing apparatus. The method may include while the mixing apparatus is activated, adding a secondary dispersant, defoamer, surfactant, biocide, freeze/thaw additive, adhesion promoter/coupling agent, and/or dispersant to the vessel to form at least a portion of a composition. The method may include causing the mixing apparatus to continue running for a first delay period. The method may include stopping the mixing apparatus and while the mixing apparatus is stopped, adding microspheres to the vessel. The method may include causing the mixing apparatus to remain stopped for a second delay period, then activating a vacuum pump to achieve a vacuum in the vessel. The method may include activating the mixing apparatus while the vessel remains under the vacuum to mix substantially all of the microspheres into the composition, then releasing the vacuum. The method may include after the releasing the vacuum, adding at least one of a functional filler, kaolin clay, and/or pH modifier and/or pigment while the mixing apparatus remains activated, then activating the vacuum pump to achieve the vacuum in the vessel containing the at least one of the functional filler, kaolin clay, pH modifier and/or pigment. The method may include causing the mixing apparatus to mix until the composition is substantially homogeneous, then releasing the vacuum while the mixing apparatus remains activated. The method may include adding an ASE thickener while the mixing apparatus remains activated. The method may include causing the mixing apparatus to continue running for a third delay period. The method may include following the third delay period, adding a pH modifier to the vessel and activating the vacuum pump to achieve the vacuum in the vessel while the mixing apparatus remains activated. The method may include causing the mixing apparatus to continue running for a fourth delay period. The method may include following the fourth delay period, deactivating the mixing apparatus and releasing the vacuum, wherein the composition in the vessel comprises the sealant composition.

### BRIEF DESCRIPTION OF DRAWINGS

Embodiments are illustrated by way of example in the accompanying figures not necessarily drawn to scale, in which like numbers indicate similar parts, and in which:

FIG. 1 illustrates a flowchart of an example method for manufacturing the disclosed composition, in accordance with various embodiments;

FIG. 2 illustrates a flowchart of a further example method for manufacturing the disclosed composition, in accordance with various further embodiments; and

FIG. 3 illustrates a graph depicting observed beneficial changes in stability corresponding with addition of surfactant quantities exceeding that expected by conventional practice, in accordance with various embodiments.

### DETAILED DESCRIPTION

In the following detailed description, numerous specific details are set forth to provide a thorough understanding of the present disclosure. However, those skilled in the art will appreciate that the present disclosure may be practiced, in some instances, without such specific details. Additionally, for the most part, specific details, and the like, have been omitted inasmuch as such details are not considered necessary to obtain a complete understanding of the present disclosure, and are considered to be within the understanding of persons of ordinary skill in the relevant art.

The present disclosure provides, in some embodiments, a product composition that is a latex system comprising a one-component, closed-cell, semi-foam, mastic sealant using gas-filled, flexible, organic microspheres to create a product that is elastic, compressible under pressure (while retaining the ability to rebound), able to function as a gasket, and, once fully cured, has properties that include vibration damping, insulating, and/or condensation-resistant. In some embodiments, the disclosed product composition can be applied by different packaging variations for differing constructional needs. Such packaging variations include, for example, an aerosol can (bag in can or bag on valve), cartridge tubes, foil tubes, squeeze tubes, and/or buckets to be applied using a brush, trowel, spatula, airless sprayer, bulk caulking gun, etc. In some embodiments, the disclosed product composition can also be formulated to be smoke-resistant and/or flame-resistant to meet various building codes. Furthermore, unlike typical mastic sealants, the disclosed product composition can be formulated to have a higher compression capability than extension capability, thereby allowing the applied composition to compress without deforming in directions outside of its applied bead line.

As discussed herein, the disclosed product composition may be formulated for use in many fields of application. For example, in one or more embodiments disclosed herein, the product composition may be formulated as a sealant or coating for ventilation ducts, joints, cracks, gaps, pipe and/or cable penetrations, gypsum drywall, and/or other areas of application. In other embodiments, the product composition may be formulated as an adhesive, for example, for parquet, wood flooring, or other applications. In some embodiments, the disclosed product composition may be formulated to provide joint/structural vibration damping, to provide insulation, for anti-condensation uses, or for smoke- and/or flame-resistant applications.

In some embodiments, vibration damping characteristics allow the product to be used to reduce noise transmission when sealing gaps or adhering substrates by dissipating the sound vibrations and reducing their audible noise detection. Examples include sealing gaps in wall cavities that would otherwise allow sound to freely travel, or adhering flooring such as parquet flooring to a subfloor to reduce the noise transmission when objects strike the floor. The vibration damping characteristics, and the capability of the composition to compress and deform in multiple directions without protruding in another direction, allows the composition to perform well as a sealant in a seismic joint system. As discussed herein, the ability of the composition to compress and/or deform without protruding means that the composition, when compressed or deformed in a particular direction, does not respond to the force of the compression or deformation of the composition by extending or expanding outwardly from the composition, but instead compresses internally due to the compressibility of the microspheres. This ability of the composition to be compressed under applied pressure in a cured film or bead without protruding out from the original cured form provides good gasket properties, even in an enclosed gap or channel.

The composition is capable of compression in both the wet phase and in its cured state. Generally, the wet-phase composition is capable of achieving a range of compression from about 15% to about 45% (and any range or value there between) of the wet-phase volume of the composition. This allows the composition to be compressed in a closed chamber, such as an aerosol can, to achieve greater amounts of the product in the closed chamber than would be achievable with the uncompressed composition. In other words, the composition, in its wet phase, may be compressed (e.g., by about 15%-45%) to fit a greater amount of the composition in the closed chamber. When in its cured state, the composition is capable of achieving a range of compression from about 50% to about 95% (and any range or value there between) of the composition's cured volume (e.g., the size of an applied composition bead or film), while maintaining the ability to rebound to the original cured volume (e.g., the original size of the applied composition bead or film). By way of contrast, other sealant compositions cannot be compressed in the manners discussed herein and, therefore, cannot achieve these effects.

In some embodiments, the disclosed product composition may be formulated to produce an aqueous or non-aqueous product that is a cross between a typical mastic sealant and a cellular foam product. In order to produce such products, various components are used to develop the backbone that supports the semi-foam final product. These various components may include: a polymeric dispersion, a surfactant package, a biocide package, a freeze/thaw package, rheology modifying additives, pH modifying additives, a defoamer additive, a plasticizer additive, a coalescing agent, various fillers, adhesion promoters (coupling agents), and/or, in some embodiments, smoke-resistant and/or flame-resistant additives. In some embodiments, these various components are combined with a high level of gas-filled, flexible microspheres to produce the disclosed one-component, semi-foam product composition. In some embodiments, the microspheres are of quite large particle size. In some embodiments, the microspheres may include, for example, Dualite® (e.g., Dualite® E065-135D), Expancel® (e.g., Expancel® 909 DET 80 d15 or MI90 DET 80 d15), and combinations thereof.

In various embodiments, the microspheres may have an average diameter of about 75 microns. In further embodiments, the microspheres may have diameters ranging from about 60 to about 90 microns (and any range or value there between). In yet further embodiments, the microspheres may both have an average diameter of about 75 microns and may have diameters ranging from about 60 to about 90 microns (and any range or value there between). Moreover, the microspheres may be Expancel®, for instance, Expancel® MI90 DET 80 d15 or Expancel® 909 DET 80 d15. In various embodiments, the microspheres are provided pre-expanded to the aforementioned diameter, such that the diameter is the expanded diameter. In various embodiments, the Expancel® MI90 DET 80d15 or Expancel® 909 DET 80 d15 microspheres have characteristics according to the following table, Table 0:

TABLE 0

| Particle Size | | |
|---|---|---|
| μm D(0.5) | True Density, kg/m³ | Solvent Resistance |
| 60-90 | 15 +/− 3 | 5 |

In various embodiments, the microspheres may have different surface chemistries. For example, a microsphere may have an organic surface chemistry. In various embodiments, an Expancel® microsphere may have an organic surface chemistry. Moreover, a microsphere may have an inorganic surface chemistry. For example, a Dualite® microsphere may have an inorganic surface chemistry. The inorganic surface chemistry may be provided by a surface coating of the Dualite® microspheres.

In some embodiments, the polymeric dispersion can be selected to withstand heavy loading with fillers, including the gas-filled microspheres. The polymeric dispersion is typically based upon acrylics or polyacrylates, but is not limited to these. Some examples of possible dispersions include: vinyl acrylic, styrenated acrylic, vinyl acetate, vinyl chloride, vinylidene chloride, ethylene vinyl acetate, butadiene styrene, butadiene acrylonitrile, acrylate acrylonitrile, and/or other dispersions of polymers and/or copolymers. Some non-aqueous options include: urethanes, silicones, polysulfides, styrene butadiene, SBS block copolymers, isoprene, silyl modified polyether, silyl modified polyurethane, and/or others.

The choice of polymeric chemical composition may depend upon the intended end use of the product. For example, lower cost/performance products that can function with lower movement and compression attributes may use the higher-Tg (glass transition temperature), lower-cost polymeric raw materials. Applications for medium movement and compression applications may use medium performance polymeric raw materials. Similarly, applications for higher movement and compression applications may use higher performing polymeric raw materials. In some embodiments, small particle size, low-Tg elastomeric polymer dispersions result in optimum performance for the finished product composition. Examples of various formulations are provided below in tables herein.

In some embodiments, the surfactant package is selected to aid in protecting the polymeric dispersion and wet out the fillers for shelf life stability. In some embodiments, the surfactant package also aides in the distribution of the particles in the liquid phase to produce a stable formulation that has viscosity stability and does not separate. This includes a wetting/emulsifying surfactant that is selected to be compatible with the polymeric dispersion, and to have the appropriate hydrophilic-lipophilic balance (HLB) value and melt point to support the finished product through electrolyte and mechanical stabilization of the polymer.

In some embodiments, the surfactant can be cationic, anionic, nonionic, Gemini (dimeric), or a combination thereof. Examples of such surfactants include: alkylphenol ethoxolate (APEO) (triton x-405) or APEO free such as Carbowet® 109, ZetaSperse® 179, Disponil® AFX 4070, and/or combinations thereof. In some embodiments, the surfactant is nonionic and, preferably, APEO (alkylphenol ethoxolate) free.

The surfactant package includes a dispersant that deflocculates the solids within the formulation allowing increased loading levels and further stabilization. Depending upon the chosen fillers, whether inorganic and/or organic, the dispersant can be low molecular weight or high molecular weight. Low molecular weight dispersants are generally more compatible with inorganic fillers. In some embodiments, especially when using clay fillers, a secondary dispersant such as tetrasodium pyrophosphate (TSPP) or potassium tripolyphosphate anhydrous (KTPP) is used to further increase the stability of the fillers and prevent re-agglomeration or flocculation. In some embodiments, such as for this highly filled type of formulation, the high molecular weight dispersant may be chosen for increased stability due to higher steric hindrance of re-agglomeration. Polyacrylates are preferred, in some embodiments, with anchoring groups that absorb onto the surface of the organic filler through hydrogen bonding, dipole-dipole interactions, and/or London-Van der Waals forces, which creates a strong steric hindrance to prevent re-agglomeration and also aids with inorganic fillers due to the high number of bound sites. The stability provided by the surfactants aides freeze/thaw stability.

Particularly challenging is the dispersal of certain microspheres within the formulation, as certain microspheres are relatively large in diameter and prone to flocculation, aggregation, and/or separation. In this respect, the certain microspheres may behave similarly to a filler. Moreover, certain microspheres have a relatively large diameter which corresponds with a relatively low density, such that the microspheres tend to float in the air. For example, such microspheres may float in the air much like dust. Such microspheres may easily become airborne, preventing easy incorporation into a waterborne sealant formulation during the mixing process. For certain microspheres, an organic shell prevents conventional methods of stabilizing a filler to be effective for stabilizing the microspheres. Novel and non-obvious methods of manufacturing further provided herein address such challenges.

In some embodiments, the biocide package is selected to protect the product composition in the in-can wet phase as well as the cured-film (dry film) phase from bacterial, fungus, and/or mildew attack during the shelf life and service life of the product under normal storage and/or usage conditions. In some embodiments, a broad spectrum biocide is chosen for the wet phase protection to keep away microbial growth of bacteria, fungi, and/or algae during the manufacturing, packaging, and in-can lifespan of the final formulation. In some embodiments, a low- or zero-VOC product is used. Examples of a low-VOC product include Mergal® 758 or Mergal® K12N. A second broad spectrum (a dry film phase) biocide may be chosen, in some embodiments, to protect the cured film from attack from microbes, bacteria, fungi, mold, and/or mildew. In some embodiments, the second broad spectrum biocide (i.e., dry film phase biocide) may include a low-VOC or zero-VOC product. Examples of a zero-VOC product include Polyphase® 678, or zinc oxide. Optimum protection loading levels may be tested by thorough microbiological testing.

In some embodiments, the freeze/thaw package is selected to protect the product composition during its storage shelf life from freeze/thaw cycles. For instance, the freeze/thaw package may be selected to protect the product composition during its storage shelf life from five or more freeze/thaw cycles resulting from ambient temperatures dropping below 32° F. The freeze/thaw package can be selected from a group of various freeze/thaw agents including ethylene glycol, propylene glycol, methanol, Rhodoline FT100, urea, and/or others. Although glycols are common, in some embodiments, urea may be preferred due to its zero-VOC content. In some formulations, urea may act as an aide for smoke and flame resistance due to its ability to function similar to a blowing agent for an intumescent package of raw materials, rather than as a fuel source.

In some embodiments, the rheology modifying additives are selected to adjust the rheology as needed to reach a specific viscosity and flow of the finished product to meet application requirements. These rheology modifying additives can include alkali swellable emulsions (ASE), associative thickeners, cellulosic thickeners, fumed silica thickeners, modified castor oils, clays, polyamides, and/or specialty mineral-based thickeners. In some embodiments, the selected rheology modifying additives and loading level may be dependent upon desired final performance characteristics such as rheology (thixotropic, thermoplastic, pseudoplastic, dilatant), slump resistance, hydrophilic or hydrophobic performance, sprayability, extrudability, brushability, and/or others.

In some embodiments, pH modifying additives may be selected to help stabilize the polymeric dispersion and/or activate the rheology modifier. These pH modifying additives can include ammonium hydroxide, potassium hydroxide, caustic soda, sodium silicate, Advantex, Vantex T, AMP, AMP-95, MEA, DEA, TEA, KOH, and/or others. In some embodiments, the selected pH modifying additives and loading level may be dependent upon several factors including, for example, system compatibility, substrate compatibility, and desired final performance characteristics such as VOC content, staining resistance, and, in the case of sodium silicate, some assistance with smoke and flame resistance due to its ability to intumesce. In some embodiments, it may be preferred to use a pH modifier that is not a VOC contributor. For smoke-resistant and/or flame-resistant formulation, the pH modifier additives may include a solution of water, caustic soda, and/or sodium silicate.

In some embodiments, the defoamer additive is used to aid in reduction of any air entrapment during the manufacturing, packaging, and storage of the product that can lead to fracture points in a highly filled system which can then diminish the cohesive strength in the final film. This can include insoluble mineral oils, silicones, certain alcohols, stearates, and/or glycols. In embodiments for water-borne sealants, the defoamer additive may be mineral-oil based.

In some embodiments, the plasticizer additive may be used to impart flexibility, flowability, softness, reduce brittleness, and in some cases, increase the resistance to smoke and flame. The plasticizer additive may include a variety of options including benzoates, phthalates, phosphate esters, and/or others. An example of such a plasticizer may include, for example, Santicizer® 148. To avoid plasticizer migration issues and potential staining issues, a polymeric binder that does not require the use of plasticizers may be used in the final system.

The coalescing agent may be used, in some embodiments, to soften the polymeric binder, lower the minimum film forming temperature, and allow the polymeric binder to flow as water leaves the sealant to create an optimum film. In some embodiments, the coalescing agent solvates the polymeric binder, evaporates slower than the water, and has low solubility in water. In some embodiments, use of a binder that does not require a coalescing agent may keep the volume solids of the sealant high.

Various fillers may be used to add various attributes to the final formulation of the product composition. Such attributes may include air blocking, structural reinforcement, moisture resistance, condensation control, thermal resistance, smoke resistance, flame resistance, reduced shrinkage, altered density, changed electro-conductivity, improved scrub resistance, reduced tack, altered optical properties, altered permeability, vibration dampening, acoustical absorption, slump resistance, stain resistance, low temperature flexibility, extension and recover, insulating, low density, easy extrudability, easy tooling, easy spray application, and/or others.

For example, in some embodiments, it may be desirable to use a particular filler to provide a pigment for coloring the composition for different applications. For example, iron oxide may be used as a filler to give the compound a red color when the composition is formulated as a firestop. In other embodiments, a particular filler may be used to color-match the formulation to a specific application. For example, a pigment, dye, paint or stain may be added to the formulation as a filler such that the composition, when applied and/or cured, achieves a particular color.

In some embodiments, the composition may be modified to achieve a particular textural appearance. For example, the composition may be modified to have a gritty texture that matches the appearance of mortar when dried. This embodiment may be useful for filling pipe penetrations in brick, such as around exterior faucets, because the composition can provide the flexibility and other sealant properties discussed herein while also giving the appearance that the pipe penetration is filled with mortar. In some embodiments, the appearance of mortar may be achieved by using large-particle-size, compressible microspheres and replacing some of the filler in the base formula with a combination of coarse fillers (such as hollow ceramic microspheres) that give the appearance of mortar sand. One such coarse filler may include a glass-hard, inert silicate in the form of high strength hollow spheres (e.g., Finite®. Another such coarse filler may include fly ash such as may be typically used in the manufacture of hollow microspheres as lightweight filler (e.g., Extendospheres®). Such coarse fillers may still allow the end product to retain the light weight density. To further enhance the appearance of mortar, a hollow, colored, light-weight sphere (such as, for example, the phenolic Phenoset™ sphere) can be added in small quantities for the appearance of red brick sand specs while still maintaining a low density in the sealant. In some embodiments, graphite or color-coated, mica black specs can be added for the appearance of black sand specs. Alternately, irregular-shaped, matted, plastic or polymeric chips or glitter can be added to simulate reddish and black sand specs. As mentioned above, in such embodiments, the end product has the appearance of mortar, but the flexibility and compressibility of a semi-foam sealant that can withstand pipe movement when attaching a hose to a faucet or other penetrations that may have pipes that move or vibrate during use.

In some embodiments, fillers such as mica, aluminum trihydrate (ATH), and/or magnesium hydroxide may be used for smoke- and flame-resistant formulations of the product composition. Mica contributes to suspension, reduced cracking, reduced shrinking, increased moisture resistance, added heat resistance, increased stiffness without compromising flexural strength, low coefficient of expansion and/or heat dimensional stability, anti-vibration, sound damping, and/or insulating properties. ATH and magnesium hydroxide decompose endothermically which leads to a temperature reduction and functions as a heat sink to retard pyrolysis and burn rate. The water that is released during decomposition dilutes combustion gases and toxic fumes. Smoke suppression is thereby achieved through this process. The aluminum trihydrate decomposes at a lower temperature than the magnesium oxide. Combining the two into the semi-foam further suppresses the smoke development in a synergistic manner.

For a semi-foam product composition that does not need to meet a smoke-retardant specification and/or a flame-retardant specification, a range of different fillers are optional depending on the application requirements of the end product. These fillers may include talc, calcium carbonate, kaolin clays, calcined clays, fumed silica, precipitated silica, carbon black, graphite, ceramic microspheres, phenolic microspheres, glass microspheres, alumino-silicate microspheres and/or others.

In some embodiments, adhesion promoters or coupling agents may be used to increase the adhesion of the product composition to various difficult-to-adhere-to substrates and to enhance moisture resistance. In some embodiments, this selection of adhesion promoters may be based on silane or stabilized non-toxic metal/organofunctional chemistry. In some embodiments, the addition of an adhesion promoter or coupling agent reduces the moisture at the substrate/sealant interface, and improves moisture resistance, temperature resistance, chemical resistance, and/or binds the organic polymers to the mineral or siliceous fillers.

In some embodiments, smoke- and flame-resistant additives may be used to create sealants that meet fire code regulations. In such embodiments, the selection of additives used affects the product composition's ability to meet specific requirements of varying building codes. In some embodiments, the semi-foam product composition contains a high loading level of gas-filled microspheres, which intuitively suggests that the final formulation would be a high risk for fire when the binder and the filler are potential fuel sources for a flame, unless the binder is flame resistant, as in the case of halogenated polymers. One embodiment includes choosing a halogenated binder, and selecting the other constituents around this choice. Thus, for binders that are not halogenated, all other choices may be more impactful during the raw materials selection process to avoid providing a fuel source, rather than smoke- and flame-retardant.

In some embodiments, a smoke-retardant and flame-retardant semi-foam sealant includes aluminum trihydrate and/or magnesium hydroxide along with mica for fillers. Adding ammonium polyphosphate or ammonium phosphate may further increase the smoke- and flame-retardant properties in some embodiments. Using prilled urea, in some embodiments, for the freeze/thaw agent also provides a blowing agent in the presence of a carbon source and an acid source to provide some intumescent properties. Using sodium silicate as part of a pH modifying solution (e.g., solution of water, sodium silicate, and/or caustic soda) may also provide some intumescent properties. In some embodiments, using acrylonitrile-based polymers and/or styrenated-acrylic-based polymers as an alternative to halogenated polymers resists flame spread.

In some embodiments, it may be preferable to avoid the use of coalescing agents, plasticizers, and/or glycols to reduce added fuel sources to the smoke-retardant and/or flame-retardant semi-foam sealant. In such embodiments, it may be preferable to use thickeners that are not fuel sources such as laponite, attapolgite, bentonite, or others.

In some embodiments, the addition of expandable graphite greatly increases the smoke and flame resistance through intumescent response to heat. Using the expandable graphite in conjunction with optimum fire resistant additives and the light weight compressible gas-filled microspheres may result in a light-weight, highly compressible, gasketing, semi-foam sealant that can function as a firestop and/or fire retardant sealant with added features such as anti-condensating surface, vibration damping, sound damping (acoustical absorption), and insulating properties. Further advantages are disclosed herein.

In addition to variations of the foregoing components, a high level of gas-filled, flexible microspheres may be included to change the sealant into a one-component, semi-foam product composition with one or more of the performance characteristics disclosed herein. In some embodiments, the amount of microspheres is about 20 to 65 volume percent (and any range or value there between) of microspheres. In some embodiments, the amount of microspheres is about 0.4 to 1.8 weight percent (and any range or value there between) of microspheres. Moreover, microspheres as used herein may have a thermoplastic shell that has been pre-expanded. The thermoplastic shell may have a softening point at a temperature outside of the ambient operating range of the product composition, such that the microspheres do not significantly expand or contract with normal changes in ambient temperature. For example, a thermoplastic shell with a major component of polyacrylonitrile may soften between about 190 degrees Celsius and about 240 degrees Celsius (and any range or value there between), whereas the semi-foam product composition may be exposed to ambient temperatures ranging from about −18 degrees Celsius to about 60 degrees Celsius (and any range or value there between).

In some embodiments, the amount of microspheres is an unusually large volume percentage. In some embodiments, the shell of the microsphere includes a thermoplastic polymer, typically constructed of acrylonitrile, copolymer of acrylonitrile, and/or other acrylics, vinylidene chloride, or methyl methacrylate. The shell may be created by encapsulating a blowing agent such as isopentane or isobutane (or similar gas with a boiling point lower than the softening point of the microsphere shell) with the polymeric shell material and expanding the shell by heating the mixture. This allows the polymeric shell to soften and the blowing agent to expand. Once cooled, the shell maintains the expanded diameter. In various embodiments, the microspheres are pre-expanded. A pre-expanded microsphere is expanded prior to introduction to the composition. As such, the microsphere in the composition may be more compressible than expandable and thus the composition may be highly compressible, at least in part due to the microspheres being biased toward greater compression rather than expansion due to having been pre-expanded. Moreover, the microsphere may resist expansion and contraction responsive to the ideal gas law because the shell provides rigidity resisting response to internal pressure changes associated with changes in temperature. However, the microsphere may yield in compressive response to mechanical loading, and may rebound in expansive response to mechanical deloading.

The shell of the microsphere can be coated with calcium carbonate or remain uncoated. Due to the polymeric nature of the shell, the expanded microspheres can be deformed or compressed without rupturing. When the compressed microspheres are returned to an ambient pressure state, they rebound back to their original expanded shape. In some embodiments, the compressibility of the microspheres allows the product to compress up to 45% (and any range or value there between) in the liquid phase in a container, and up to 95% (and any range or value there between) once applied and fully cured. This compressible attribute allows the semi-foam sealant to be applied via spray despite the high volume solids content of the finished product. This compressible attribute allows the semi-foam sealant to be applied via spray despite the high viscosity of the finished product. It also allows the finished product to be heavily loaded under pressure into an aerosol can, such as a bag on valve or piston can or other aerosol can, at a higher sealant volume than the actual physical volume of the aerosol can to maximize the applied linear footage of the sealant upon application, when compared to non-compressible sealants. The compressibility also allows a high volume solids sealant to be applied by an aerosol can with extended coverage. The microspheres also allow the product to be molded or tooled after being applied without losing its sealing properties. This is at least partially because the microspheres act as closed cell technology in a formulation.

Unlike typical sealants which lack gasketing properties, the final product composition can use one or a combination of multiple grades of microspheres to reach the desired balance of compressibility, elongation, cohesive strength, and density. Moreover, typical open cell spray foams are not trimmable or toolable after application or the sealing properties are harmed, whereas the final product composition is trimmable and toolable. In some embodiments, the microspheres have a particle size ranging from about 15 μm to about 200 μm (and any range or value there between). In some embodiments, the preferred particle size range is from about 60 μm to about 90 μm (and any range or value there between) with a density of about 12 kg/m³ (0.012 g/cm³) to about 18 kg/m³ (0.018 g/cm³) (and any range or value there between) to create a good balance of attributes in the finished product. In some embodiments, the preferred particle size range is from about 60 μm to about 90 μm (and any range or value there between) with a density of about 15 kg/m³ (0.015 g/cm³) to create a good balance of attributes in the finished product.

In some embodiments, the microspheres have a density ranging from about 6.5 kg/m³ to about 100 kg/m³ (and any range or value there between). For example, various embodiments of Expancel® microspheres discussed herein may have a density ranging from about 6.5 kg/m³ to about 100 kg/m³ (and any range or value there between). In some embodiments, the microspheres have a density ranging from about 25 kg/m³ to about 100 kg/m³ (and any range or value there between). In some embodiments, the embodiments of Expancel® microspheres discussed herein have a particle size ranging from about 15 μm to about 200 μm (and any range or value there between). In some embodiments, embodiments of Expancel® microspheres discussed herein are provided with a preferred particle size range from about 60 μm to about 90 μm (and any range or value there between) with a density of about 12 kg/m³ (0.012 g/cm³) to about 18 kg/m³ (0.018 g/cm³) (and any range or value there between) to create a good balance of attributes in the finished product. In some embodiments, embodiments of Expancel® microspheres discussed herein are provided with a preferred particle size range from about 60 μm to about 90 μm (and any range or value there between) with a density of about 15 kg/m³ (0.015 g/cm³) to create a good balance of attributes in the finished product.

In some embodiments, the microspheres have a density ranging from about 25 kg/m³ to about 200 kg/m³ (and any range or value there between). For example, various embodiments of Dualite® microspheres discussed herein may have a density ranging from about 25 kg/m³ to about 200 kg/m³ (and any range or value there between). In some embodiments, the microspheres are provided with about 0.4 to about 1.8 weight percent (and any range or value there between) of a composition. Moreover, in further embodiments, the preferred particle size range is from about 124 μm to about 145 μm (and any range or value there between) with a density of about 65 kg/m³ (0.065 g/cm³). For example, implementations of Dualite® microspheres having a calcium carbonate coating may include a preferred particle size range from about 124 μm to about 145 μm (and any range or value there between) with a density of about 65 kg/m³ (0.065 g/cm³). In example implementations of Dualite® microspheres provided herein, the microspheres may be as about 0.4 to about 1.8 weight percent (and any range or value there between) of a composition.

These specifications allow a finished product composition that, once applied and cured, becomes a syntactic foam product with the ability to be compressed from about 50% to about 95% (and any range or value there between) of its original bead size without deformation in a direction outward from the cured sealant bead diameter, and to then rebound once the applied pressure is released. This functionality gives the finished, cured product the ability to be elastic, compressible, vibration damping, gasketing, insulating, and anti-condensating. Additionally, the product composition has sufficient cohesive strength to perform well for various applications including in areas prone to vibrating, shifting, or otherwise moving. The product can be applied in multiple delivery systems including sprayable systems such as airless sprayers and aerosol cans, and other systems such as brush, trowel, spatula, cartridge tube, foil tube, and squeeze tube. With special selection of raw materials and the addition of fire retardant additives, the cured finished product can also be formulated to be a fire retardant or firestop sealant.

In some embodiments, the finished product composition results in a mastic sealant that is greater than about 70 volume percent (and any range or value there between) of solids with the ability to be applied by spray application.

In some embodiments, the latex system is highly loaded with gas-filled microspheres resulting in a highly-filled mastic sealant that does not require plasticizer, thereby improving resistance to staining, eliminating plasticizer migration, eliminating plasticizer off-gassing, and improving compatibility with substrates such as CPVC.

In some embodiments, the latex system is highly loaded with gas-filled microspheres resulting in a highly-filled sealant that does not require coalescing agents for film formation and has improved compatibility with substrates such as CPVC.

In some embodiments, the latex system is highly loaded with gas-filled microspheres that can be formulated to be a light-weight, compressible, flexible firestop and/or fire retardant sealant.

The following tables provide various example formulations. The ranges and values disclosed by the exemplary formulations in the tables are understood to be prefaced by the terms “about” or approximately.” As used herein, the terms “about” and “approximately” mean the stated range or value plus or minus a margin of error if a method of measurement is indicated, or plus or minus 10% if no method of measurement is indicated.

TABLE 1

| | % Weight | | % Volume | |
|---|---|---|---|---|
| | Range | | Range | |
| Raw Material Category | Min | Max | Min | Max |
| Polymer Dispersion | 52.1 | 85.14 | 39.03 | 59.1 |
| Microspheres | 0.4 | 1.62 | 20.81 | 55.1 |
| Surfactant | 0.68 | 2 | 0.51 | 1.7 |
| Dispersant | 0.34 | 1.8 | 0.27 | 1.3 |
| Freeze/Thaw additive | 0.7 | 3.35 | 0.6 | 1.3 |
| Biocide (Dry Film) | 0.04 | 0.5 | 0.03 | 0.4 |
| Biocide (Wet/In-Can) | 0.04 | 0.5 | 0.03 | 0.4 |
| Defoamer | 0.04 | 0.69 | 0.04 | 0.46 |
| Thickener | 0.37 | 4 | 0.2 | 3.2 |
| pH Modifier | 0.3 | 2.02 | 0.2 | 1.21 |
| Diluent (Water) | 0 | 12 | 0 | 10.2 |
| Smoke and/or Flame Retardant | 0 | 27.58 | 0 | 12.33 |
| Functional Filler | 0 | 6.66 | 0 | 1.64 |
| Filler | 0 | 6.71 | 0 | 1.7 |
| Adhesion Promoter | 0 | 0.3 | 0 | 0.2 |

Table 1 is an example of a composition according to the disclosure herein. Specific embodiments of this composition are provided in further tables herein below. With reference to Table 1, various features will now be discussed. In some instances, a polymer dispersion may range from 50 to 67 weight percent (and any range or value there between) of solids (dry) polymer content, in water. As such, the polymer dispersion may have a weight percent range and/or volume percent range as provided in Table 1.

Moreover, the notable difference in percent weight and percent volume of microspheres reflects the relative low density of the microspheres. For instance, in various embodiments implementing Expancel® microspheres, the microspheres may exhibit a density ranging from 0.012 g/cm³ to 0.018 g/cm³ (and any range or value there between).

Additionally, surfactants may typically exhibit short-term stability with greater than or equal to 0.65 weight percent. Notably, however, in various commercially viable products, such as products with a shelf life above 9 months, the surfactants may be provided with greater than or equal to 0.80 weight percent (and any range or value there between). Furthermore, in various commercially viable products, such as products with a shelf life of at least 12-18 months, the surfactants may be provided with greater than or equal to 1.0 weight percent (and any range or value there between).

Smoke and/or flame retardants are reflected in Table 1, however, in various embodiments, smoke and/or flame retardants are optional. For example, smoke and flame retardants may be included in a formulation designed for a smoke and flame retardant sealant. Smoke and/or flame retardants may be omitted in a formula designed for implementations other than as a smoke and/or flame retardant sealant. In yet further instances, smoke and/or flame retardants contribute to increased solids content to reduce overall shrinkage during cure.

Fillers and/or functional fillers may be provided in some embodiments. Fillers and/or functional fillers may be omitted in some embodiments. Fillers may be provided to reduce cost, or to raise overall solids content to reduce shrinkage during cure. ASTM C-834 has a volume shrinkage test (ASTM C1241) that, in connection with fillers, may facilitate achievement of specification requirements. Aesthetical considerations and overall performance is, in various embodiments, enhanced with increasing solids content such as may be provided by fillers. Moreover, higher solids content may decrease curing rates. Fillers may be added to add reinforcement. For instance, fillers may increase adhesive and/or cohesive strength which may improve shear or tensile strength. Fillers may enhance water resistance, chemical resistance, weather resistance, and/or rheological properties for ease of application. In various embodiments, some fillers, such as fine fillers may decrease tack. In various embodiments, some fillers, such as course fillers may maintain and/or increase tack. Fillers may be implemented to reduce overall formulation cost. Fillers may be implemented to influence permeance rating of a cured sealant. Fillers may be implemented to add pigment, or to add UV resistance, or to add other specific attributes, such as to enhance smoke and/or flame retardancy. Many various embodiments will include fillers of some category selected to achieve specification requirements.

Adhesion promotors (or coupling agents) may be added in some embodiments. Adhesion promotors (or coupling agents) may provide for increased substrate adhesion for the sealant to meet specification requirements. In various embodiments, adhesion promotors (or coupling agents) may provide for increased moisture resistance for the sealant to meet specification requirements.

Diluents may be added in some embodiments. In various embodiments, a diluent may be water. A diluent may be added to lower solids content. In various embodiments, sufficient water is added so that there exists a continuous water phase of an oil/water dispersion.

Table 2 is an example formula for a product having a density of about 0.57 g/cm³. The formula in Table 2 is an aqueous formulation capable of over about 85% of compression. It may be used for sealing cracks, is excellent for aerosol can application, is moisture resistant, and is an excellent base formula for outdoor applications such as filling pipe penetrations, mortar repair, etc. In various embodiments, this formula is applied using aerosol cans that have a barrier between the propellant and the product such as piston cans and bag on valve cans. The formula in Table 2 exhibits the various attributes listed with the exception of smoke and flame resistance. It is excellent for sealing in buildings with known joint movement, is acceptable to addition of pigments for aesthetic appearance, and is compatible with CPVC piping.

TABLE 2

| Raw Material | | % | % |
|---|---|---|---|
| Category | Raw Material | Weight | Volume |
| Acrylic Polymer | Rhoplex EC-3814 | 85.14 | 46.92 |
| Diluent | Water | 5.91 | 3.36 |
| Defoamer | Foamaster 75 | 0.69 | 0.46 |
| Surfactant | Carbowet 109 | 1.02 | 0.54 |
| Biocide | Polyphase 678 | 0.20 | 0.09 |
| Biocide | Mergal K12N | 0.30 | 0.16 |
| Freeze/Thaw Additive, | Prilled Urea | 2.20 | 0.94 |
| Blowing Agent | | | |
| Dispersant | Orotan 731 dp | 0.39 | 0.34 |
| Microspheres | Expancel 909 DET 80 | 1.22 | 46.21 |
| | d15 (or Expancel MI | | |
| | 90 DET 80 d15) | | |
| Filler | Talc MP4526 | 1.97 | 0.40 |
| HASE | Polyphobe TR115 | 0.37 | 0.20 |
| pH Modifier | Ammonia | 0.59 | 0.37 |

Table 3 is an example formula for a product having a density of about 0.52 g/cm³. The formula in Table 3 is an aqueous formulation capable of over about 87% of compression. It may be used for sealing cracks, is excellent for aerosol can application, is moisture resistant, and is an excellent base formula for outdoor applications such as filling pipe penetrations, mortar repair, etc., and exhibits the various attributes listed with the exception of smoke and flame resistance. In various embodiments, this formula is applied using aerosol cans that have a barrier between the propellant and the product such as piston cans and bag on valve cans. This formula may be excellent for sealing in buildings with known joint movement, is acceptable to addition of pigments for aesthetic appearance, and is compatible with CPVC piping. The formula exhibits increased adhesion to difficult substrates, increased moisture resistance, increased UV resistance, high volume solids for minimal shrinkage and fast cure, and has extremely low density. Compositions of Tables 2 and 3 can also be applied by typical application methods.

TABLE 3

| Raw Material | | % | % |
|---|---|---|---|
| Category | Raw Material | Weight | Volume |
| Acrylic Polymer | Rhoplex EC-3814 | 81.61 | 40.96 |
| Defoamer | Foamstar 2420 | 0.34 | 0.20 |
| Surfactant | Disponal AFX 4070 | 1.12 | 0.54 |
| Biocide | Polyphase 678 | 0.18 | 0.08 |
| Biocide | Mergal 758 | 0.34 | 0.16 |
| Functional Filler | Aerosil 200 | 0.22 | 0.05 |
| Freeze/Thaw Additive, | Prilled Urea | 3.35 | 1.30 |
| Blowing Agent | | | |
| Dispersant | Orotan 731 dp | 0.36 | 0.29 |
| Microsphere | Expancel 909 DET 80 | 1.57 | 53.97 |
| | d15 (or Expancel MI | | |
| | 90 DET 80 d15) | | |
| Filler | Talc MP4526 | 6.71 | 1.24 |
| Adhesion Promoter/ | Organosilane KBM | 0.18 | 0.09 |
| Coupling Agent | 403 | | |
| Functional Filler | Titanium Dioxide | 2.46 | 0.32 |
| HASE (Hydrophobic | TT-615 | 0.56 | 0.27 |
| Alkali Swellable | | | |
| Emulsion) Thickener | | | |
| pH Modifier | 20% Caustic Soda | 1.01 | 0.54 |

Table 4 is an example formula for a product having a density of about 0.51 g/cm³. This formula is an aqueous formulation capable of over about 85% of compression with the listed attributes, including smoke and flame retardant properties. It has potential additional use as a light-weight firestop sealant with the ability to apply from an aerosol can or airless sprayer as well as typical application methods. In various embodiments, this formula is applied using aerosol cans that have a barrier between the propellant and the product such as piston cans and bag on valve cans. This formula may be CPVC pipe compatible.

TABLE 4

| Raw Material | | % | % |
|---|---|---|---|
| Category | Raw Material | Weight | Volume |
| Acrylic Polymer | Rhoplex EC-3814 | 78.85 | 39.03 |
| Defoamer | Foamstar 2420 | 0.32 | 0.19 |
| Surfactant | Disponal AFX 4070 | 1.08 | 0.51 |
| Biocide | Polyphase 678 | 0.17 | 0.07 |
| Biocide | Mergal K12N | 0.28 | 0.14 |
| Functional Filler | Aerosil 200 | 0.22 | 0.05 |
| Freeze/Thaw Additive, | Prilled Urea | 3.24 | 1.24 |
| Blowing Agent | | | |
| Dispersant | Orotan 731 dp | 0.35 | 0.27 |
| Carbon Black Pigment | Black Dye Multijet | 0.06 | 0.03 |
| Dispersion | 707 | | |
| Microsphere | Expancel 909 DET 80 | 1.62 | 55.10 |
| | d15 (or Expancel MI | | |
| | 90 DET 80 d15) | | |
| Expandable Graphite | Asbury 3626 | 9.72 | 2.21 |
| Adhesion Promoter/ | Organosilane KBM | 0.19 | 0.09 |
| Coupling Agent | 403 | | |
| Functional Filler | Titanium Dioxide | 2.38 | 0.30 |
| ASE (Alkali Swellable | Viscoatex 730 | 0.54 | 0.26 |
| Emulsion) Thickener | | | |
| pH Modifier | 20% Caustic Soda | 0.97 | 0.51 |

Table 5 is an example formula for a product having a density of about 0.69 g/cm³. This formula is an aqueous formulation capable of over about 80% of compression. It may be used indoors, and allows for easy-to-clean for application equipment, and over-spray. This formula is excellent for fire resistance sealant in areas that need to meet building codes, is great for buildings with known joint movement, is acceptable to addition of pigments for aesthetic appearance, and is compatible with CPVC piping. This formula may be applied from an aerosol can or airless sprayer as well as typical application methods. In various embodiments, this formula is applied using aerosol cans that have a barrier between the propellant and the product such as piston cans and bag on valve cans. The formula has potential additional uses such as parquet flooring adhesive. The product remains flexible at zero degrees Fahrenheit (about −17.8 degrees Celsius). Due to the choices of polymer, fillers, and additives, this formulation performs as a good air barrier with a standard permeance (perms) of 21 and thermal insulating attributes, has a VOC content of zero according to Method 24 testing, and an elongation at break of about 214%.

TABLE 5

| Raw Material | | % | % |
|---|---|---|---|
| Category | Raw Material | Weight | Volume |
| Acrylate-Acrylonitrile | Acronal 81 D | 61.71 | 40.36 |
| Copolymer | | | |
| Diluent | Water | 3.61 | 2.50 |
| Defoamer | Foamstar 2420 | 0.17 | 0.13 |
| Surfactant | Disponil AFX 4070 | 1.19 | 0.82 |
| Biocide | Polyphase 678 | 0.12 | 0.07 |
| Biocide | Mergal 758 | 0.28 | 0.19 |
| Freeze/Thaw Additive, | Prilled Urea | 2.09 | 1.08 |
| Blowing Agent | | | |
| Dispersant | Tamol 851 | 0.95 | 0.55 |
| Color Pigment | Phthalo Blue - | 0.36 | 0.21 |
| Dispersion | Plasticolors | | |
| Microsphere | Expancel 909 DET 80 | 1.07 | 44.26 |
| | d15 (or Expancel MI | | |
| | 90 DET 80 d15) | | |
| AP Flame Retardant | JJAZZ(4MA2) | 3.04 | 1.59 |
| Functional Filler | Mica WG325 | 6.66 | 1.64 |
| Functional Filler/Smoke | Aluminum Trihydrate | 15.22 | 4.40 |
| and Flame Retardant | SB432 | | |
| ASE Thickener | Thickener P-1172 | 1.52 | 0.99 |
| pH Modifier | 20% Caustic Soda | 2.02 | 1.21 |

Table 6 is an example formula for a product having a density of about 0.67 g/cm³. This formula is an aqueous formulation capable of over about 80% of compression with the listed attributes, including smoke and flame retardant properties. It has potential additional use as a light-weight firestop sealant with the ability to apply from an aerosol can or airless sprayer as well as typical application methods. In various embodiments, this formula is applied using aerosol cans that have a barrier between the propellant and the product such as piston cans and bag on valve cans. This formula is CPVC pipe compatible, has good adhesion to metal, and exhibits extremely low to no slump when applied.

TABLE 6

| Raw Material | | % | % |
|---|---|---|---|
| Category | Raw Material | Weight | Volume |
| Acrylic Polymer | Rhoplex EC-3814 | 72.45 | 47.19 |
| Diluent | Water | 5.03 | 3.38 |
| Defoamer | Foamaster 75 | 0.25 | 0.20 |
| Surfactant | Carbowet 109 | 0.87 | 0.54 |
| Biocide | Polyphase 678 | 0.17 | 0.09 |
| Biocide | Mergal K12N | 0.25 | 0.16 |
| Freeze/Thaw Additive, | Prilled Urea | 2.51 | 1.27 |
| Blowing Agent | | | |
| Dispersant | Orotan 731 dp | 0.34 | 0.35 |
| Color Pigment | Phthalo Blue - | 0.30 | 0.17 |
| Dispersion | Plasticolors | | |
| Microspheres | Expancel 909 DET 80 | 0.92 | 41.23 |
| | d15 (or Expancel MI | | |
| | 90 DET 80 d15) | | |
| Functional Filler/Smoke | Aluminum Trihydrate | 6.70 | 1.88 |
| and Flame Retardant | SB432 | | |
| Mineral Thickener | Laponite RDS | 2.31 | 0.74 |
| Expandable Graphite | Asbury 3626 | 6.70 | 2.00 |
| ASE Thickener | Viscoatex 730 | 0.50 | 0.32 |
| Tertiary Amine pH | Vantex T | 0.70 | 0.49 |
| Modifier | | | |

Table 7 is an example formula for a product having a density of about 0.99 g/cm³. This formula is an aqueous formulation capable of over about 60% of compression. This formula exhibits fast skinning and fast cure for an aqueous sealant. It may be used as a moisture resistant, fire retardant sealant for building penetrations, cracks, and gaps.

TABLE 7

| Raw Material | | % | % |
|---|---|---|---|
| Category | Raw Material | Weight | Volume |
| Styrenated Acrylic | Rhoplex 2019RX | 30.99 | 29.70 |
| Polymer | | | |
| Acrylic Polymer | Rhoplex EC-3000 | 30.65 | 29.40 |
| Diluent | Water | 3.00 | 2.97 |
| Defoamer | Foamaster 75 | 0.26 | 0.30 |
| Surfactant | Carbowet 109 | 0.68 | 0.62 |
| Plasticizer | Santicizer 148 | 1.70 | 1.65 |
| Biocide | Polyphase 678 | 0.07 | 0.06 |
| Biocide | Mergal K12N | 0.16 | 0.15 |
| Freeze/Thaw Additive, | Prilled Urea | 1.36 | 1.01 |
| Blowing Agent | | | |
| Dispersant | Orotan 731 dp | 0.34 | 0.52 |
| Color Pigment | Phthalo Blue - | 0.22 | 0.18 |
| Dispersant | Plasticolors | | |
| Microspheres | Dualite E065-135D | 1.36 | 20.81 |
| Filler | Magnapearl 1000 | 2.04 | 0.67 |
| Functional Filler/Smoke | Aluminum Trihydrate | 25.88 | 10.68 |
| and Flame Retardant | SB432 | | |
| HASE Thickener | Polyphobe 115 | 0.31 | 0.28 |
| ASE Thickener | Viscoatex 730 | 0.16 | 0.15 |
| Tertiary Amine pH | Vantex T | 0.82 | 0.84 |
| Modifier | | | |

Further compositions are disclosed which address various challenges relating to the development of sealants. For instance, many prior sealants have a density between 12-14 pounds per gallon. Consequently, large containers are not easily portable and often exceed acceptable weights to be carried by hand. For example, regulations may prohibit workers from carrying containers of prior sealants of meaningful quantity to and around their job location, due to their weight.

The sealant disclosed herein is significantly lighter, however. It has been determined that the addition of relatively large microspheres to the sealant reduces the density significantly, and correspondingly, the weight. For example, while prior sealants may include 40 micron microspheres, compositions disclosed herein may implement 80 micron microspheres, or may implement microspheres ranging, for example, from about 60 to 120 microns (and any range or value there between) in diameter. In various embodiments, microspheres may be lightweight and of relatively large size. In various embodiments, microspheres may be Expancel MI 90 DET 80 d15 from Nouryon (formerly Akzo Nobel). In various embodiments, microspheres may be Expancel 909 DET 80 d15 from Nouryon (formerly Akzo Nobel).

However, due to the large size of such microspheres, it is difficult to stabilize the spheres in the polymeric aspect of the composition. As used herein, stabilization may mean stabilization of the polymer particles of the polymer emulsion and the polymer shell of the microspheres along with the pigment particles to impart mechanical stability, freeze-thaw stability, and shelf-life stability. Mechanical stability means that the sealant can withstand the mixing process and application process without adversely agglomerating into an unusable mass. Freeze-thaw stability means that the formulated sealant can be capable of undergoing three to five cycles of freezes followed by thawing and still remain a working, usable sealant that has not agglomerated into an unusable mass. Shelf-life stability means that the formulated sealant will not agglomerate into an unusable mass or separate into layers of materials that will not function as the sealant was originally intended as it ages in a closed container while exposed to various normal storage conditions throughout a specified shelf life, typically between 6 months to 24 months depending upon the formulation components, with 12 to 18 months being the most typical. The combination of large particle size microspheres with the large volume of microspheres added to the referenced formulations presented a difficult challenge to stabilize.

Two major molecular interactions are important to the achievement of stabilization. First, to make a film-forming aqueous product, there should be provided a binder that can be dispersed in the aqueous phase. To do this one may emulsify the binder in water using a surfactant that can micellize around the binder and suspend and disperse it in water.

Second, when adding fillers to the emulsion (binder) to tailor a product that has the desired attributes and specifications that the end product requires, additional surfactant and dispersant may be provided to maintain stability (to prevent settling, syneresis, coalescing, in-can film forming, changes in viscosity, flocculation or complete agglomeration). To do this, one may add dispersants when adding fillers (most fillers are inorganic) which will have an affiliation with the surface of the filler and will repulse and stabilize the filler particles from each other and from the emulsified binder micelles to ensure that the binder micelles stay intact for the shelf life of the product or until it is applied.

It is also possible for fillers to absorb the surfactants that are stabilizing the binder in the naturally-occurring exchange of molecules, robing the binder of its ability to remain dispersed and suspended in the emulsion. Therefore, one may use additional surfactant in conjunction with dispersant to stabilize an end-product. However, there are limitations on how much surfactant one can use in the end-product. Too much surfactant can render the binder useless. The emulsified binder works by capillary actions that allow the polymeric material to coalesce as water evaporates from the film. An overdose of surfactant will disrupt this mechanism therefore preventing film formation, adhesion, cohesion and drying.

When formulating with large microspheres, prior efforts to cure this stability concern include treating the microspheres like a filler and adding dispersant to attempt to improve stabilization of the spheres in the polymeric aspect of the composition through steric hindrance and/or electrostatic repulsion (which would be expected for most microsphere fillers). However, it has been found that such efforts result in an agglomerated thick mass that is rendered useless since the dispersant does not lower the interfacial tension between the liquid (water/emulsion) phase and solid (acrylonitrile shell of the microsphere) phase. This lowering is known as wetting and is one attribute necessary to acquire stabilization of the microspheres within the liquid medium. Such a thick agglomerated mass could no longer form a film, suggesting that the film-forming polymer micelles were robbed of their stabilizing surfactant layer during the mixing process.

Thus, and contrary to expectations, the microspheres do not behave like an inert filler, which is contrary to the behavior of most lightweight microspheres such as Dualite®. Dualite® is a polymeric microsphere coated with calcium carbonate which is an inert inorganic filler and therefore is compatible for conventional stabilization techniques for microsphere fillers in an aqueous medium. Additionally, expanded glass microspheres, ceramic microspheres, and/or fly ash microspheres are examples of inert inorganic microspheres that would be stabilized like an inert filler. Organic microspheres coated with an inert inorganic filler such as calcium carbonate (as is the case for Dualite® microspheres) can also be stabilized conventionally.

However, it has been unexpectedly determined that such conventional efforts fail for microspheres herein, and particularly the microspheres of Tables 2-6 and 8a, 8b, 8c, 8d. For instance, some microspheres used herein do not have an inert inorganic coating such as calcium carbonate. For instance, Expancel® microspheres used in the Tables 8a, 8b, 8c, 8d formulation are not coated with an inert inorganic filler and thus exhibit even greater stabilization challenges and resist stabilization by conventional stabilization techniques for microsphere fillers in an aqueous medium.

Applicant has discovered that this failure arises at least in part due to the relatively low density and large size of the microspheres and in part due to buoyancy. Large and low-density hollow gas filled microspheres will displace more volume of the fluid medium of the formulation than small and high-density microspheres, causing a larger buoyancy force to push the large microspheres towards the surface of the liquid medium of the formulation compared to the buoyancy force pushing on smaller and more dense microspheres or particles. Additionally, the extremely low density of the large and low-density hollow gas filled microspheres contributes with the buoyancy forces to impede efforts to mix in and stabilize the large, low-density microspheres to keep them suspended relatively uniformly within the medium of the formulation, especially for an extended period of time to reach shelf life expectancies. The microspheres used with a particle size between 60 and 90 microns (and any range or value there between) and a density below about 60 kg/m³ and especially below about 20 kg/m³ will be under constant relatively high buoyancy force tending to impel them to travel to the surface to float. For instance, the Expancel® microspheres have a density below about 18 kg/m³ and especially below about 12 kg/m³.

In addition, and as mentioned, yet further failure arises at least in part due to the surface chemistry of the Expancel® microspheres causing even greater stabilization challenges and resistance to stabilization by conventional stabilization techniques for microsphere fillers in an aqueous medium.

It has been unexpectedly determined that one solution to the challenge of stabilizing the relatively massive microspheres includes treating the microspheres like a binder, rather than a filler, and contrary to the expectations of one having ordinary skill in the art. In various embodiments, rather than using dispersants to disperse the microspheres, it has unexpectedly been determined that surfactant provides an effective solution. For instance, dispersants must be capable of adsorbing onto the surface through anchoring groups and stabilizing the system with polymeric chains that give steric stabilization, typically through ionic structure elements. The Expancel® microspheres discussed in embodiments herein often include nonpolar organic shells that do not allow the dispersants to adsorb. Consequently, rather than dispersant, a large amount of surfactant (wetting agent) is added.

The surface tension of water is higher than the surface tension of embodiments of Expancel® microspheres selected for formulations provided herein. Consequently, it is difficult to wet out the microspheres without copious amounts of surfactant that will lower the surface tension of the water phase. Conventional efforts to wet out the microspheres results in an agglomerated thick mass that is rendered useless since a dispersant does not lower the interfacial tension between the liquid (water/emulsion) phase and solid (acrylonitrile shell of the microsphere) phase. This lowering is known as wetting and is one attribute necessary to acquire stabilization of the microspheres within the liquid medium.

However, the introduction of surfactant in amounts conventionally considered to be excessive provides an unexpected result. For example, the hydrophobic tail ends of the surfactant have an affinity for the surface of the Expancel® microspheres, facilitating wetting out of the microspheres. The hydrophilic heads of the surfactant have an affinity for the water phase of the formulation and therefore help incorporate the Expancel® microspheres into the water phase to distribute and stabilize the microspheres within the formulation.

Such distribution and stabilization is challenging due to the previously discussed high buoyancy force exerted upon the microspheres, as well as the low surface tension of the microspheres and the surface chemistry of the microspheres. It has been unexpectedly determined that the high loading level of surfactant improves stabilization of the microspheres in the polymeric aspect of the composition, maintaining and stabilizing emulsification in an aqueous phase. In prior efforts for stabilization of products that do not contain the Expancel® microspheres, surfactant in a quantity of, for instance, 0.2 to 0.5 weight percent (and any range or value there between) of the composition, was used for optimum results, whereas, herein, much more surfactant is needed to reach maximum stability.

As also mentioned, there is mechanical stability, freeze-thaw stability, and shelf-life stability. It was found that using the conventional surfactant quantity, from about 0.2 to about 0.5 weight percent (and any range or value there between), the relatively massive microspheres, such as the Expancel® microspheres, caused mechanical instability and therefore the attempted formulations would not last through the mixing process. Rather the formulations would coagulate at the time of mixing or shortly after into an unusable mass. After multiple failed attempts, the surfactant levels of the batches containing microspheres were increased from 0.8 to 1.1% weight percent (0.5 to 0.6 volume percent) (Tables 2, 3, 4 and 6). This achieved mechanical stability and a moderate shelf-life stability of 3 to 12 months but did not achieve freeze-thaw stability. The products were usable only if they were protected from extreme storage conditions and within a relatively short period of time. This is impractical for large commercialization of a product in some use scenarios. Against conventional practice and the prior understanding in the art, the surfactant was again raised from about 1.19 to about 1.5 weight percent (about 0.8 to about 1.3% volume percent), (Tables 5 and 8). Finally, mechanical, freeze-thaw, and shelf life of 18 to 24 months was achieved. Thus, in various embodiments, the amount of surfactant may be from about 1.1 weight percent to about 2.0 weight percent (and any range or value there between).

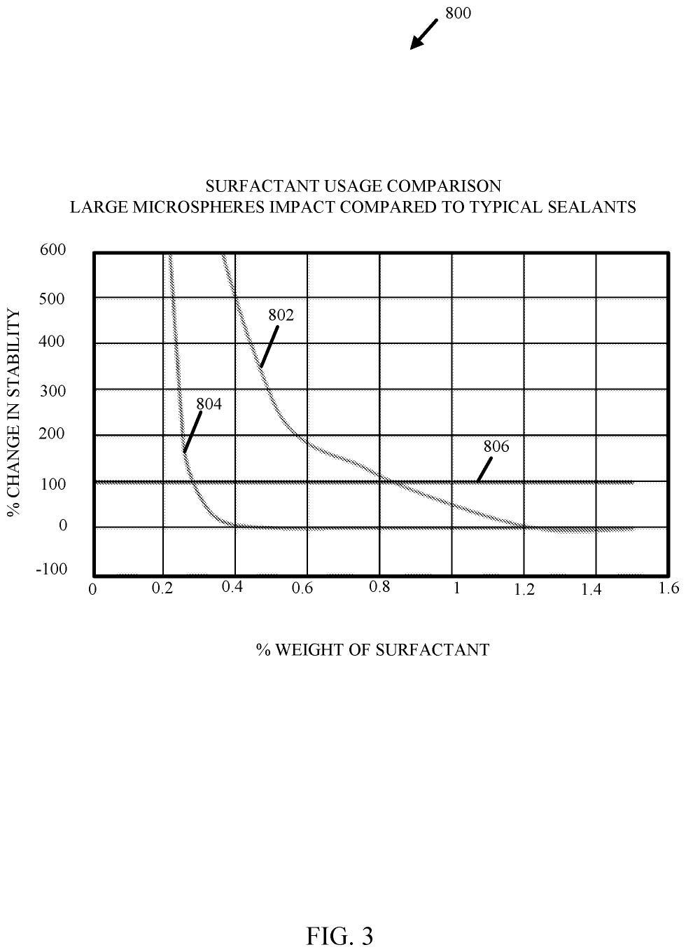

In FIG. 3, a graph 800 is provided that illustrates the observed beneficial changes in stability corresponding with addition of surfactant quantities exceeding that expected by conventional practice. The graph 800 illustrates observed changes in stability over the course of a typical shelf life of 18-24 months between a typical sealant (e.g., standard waterborne sealant) and a sealant containing microspheres as provided herein (e.g., Expancel® with a particle size ranging from 60-90 microns.) For this example, the typical sealant and sealant containing microspheres are of similar viscosity and solids percent content. The right-most curve 802 depicts the behavior of the sealant containing microspheres and the left-most curve 804 depicts the behavior of the typical sealant. The horizontal line 806 at 100% change in stability divides a region above the line where stability decreases at least 100% over the shelf life period from a region below the line where the stability decreases less than 100% (and approaching no decrease in stability) over the shelf life period. As illustrated, relatively large amounts of surfactant in quantity exceeding that conventional in the art promote improved long-term stability.

A person having ordinary skill in the art would think such quantities of surfactant would cause other serious problems and would think such a quantity of surfactant would not be a practical solution. The conventional understanding in the art is that such quantities of surfactant would cause poor adhesion, poor performance, poor moisture resistance, increased foaming, interference with associative thickeners impacting formulation rheology and poor drying of the composition. Such quantities of surfactant would be expected to lead to surfactant leaching (also known as weeping) leaving a sticky, oily, soapy or sap-like substance on the surface of the film or causing irregular surface discoloration, especially in high heat and humidity conditions. There are limitations on how much surfactant one can use in the end-product. However, it has been unexpectedly discovered that such oversaturation does not occur with the compositions as provided.

The emulsified binder forms a film by capillary actions that allow the polymeric material to coalesce as water evaporates from the film. Conventionally, it would be expected that the high loading level of surfactant would interact deleteriously with the polymer and disrupt this mechanism therefore preventing film formation, adhesion, cohesion and drying. However, the composition wets out and properly creates a continuous film during curing despite exceeding conventionally acceptable quantities of surfactant. It has been discovered that the large surface area of the microspheres, coupled with the high affinity of the microspheres for the surfactant, causes the surfactant to be suspended with the microspheres in the water phase and attach to it. Consequently, the conventional understanding of expected separation of the microspheres and the polymer components of the composition does not occur.

Conventionally, it also would be expected that the high loading level of surfactant would interact deleteriously with the polymer. For instance, the emulsified binder works by capillary actions that allow the polymeric material to coalesce as water evaporates from the film, but a high loading level of surfactant will disrupt this mechanism and prevent film formation, adhesion, cohesion and drying. But it has been discovered that the surfactant acts like a dispersant on the surface of the large microspheres, because the surfactant has a very high affinity for the microspheres and the microspheres provide a large surface area for binding. As such, the surfactant interacts with the microspheres as it would with the binder. Due to the high affinity of the relatively massive microspheres for the surfactant, it is apparent that when using conventional loading levels of surfactant, the microspheres were competing with the binder for surfactant causing the surfactant starved binder to destabilize under mechanical shear during the mixing process.

It has also been unexpectedly discovered that the relatively large size and high loading level of microspheres facilitates innovations in methods of applying the formula. In various embodiments, the sealant with density modifier has a viscosity of about 150,000 cP to about 350,000 cP (and any range or value there between) (such as in Table 5). Another unit of viscosity measurement is a Krebs unit (KU) measured by a Stormer Viscometer. A Stormer Viscometer is often used to measure the viscosity of spray-grade coatings. However, such a viscosity is beyond the ability of a Stormer Viscometer to measure in Krebs units. Krebs units typically only reach 141 KU. In various embodiments, such as that provided in Tables 8a, 8b, 8c, 8d, a composition may be provided with a viscosity of about 300,000 cP to about 500,000 cP (and any range or value there between). In various embodiments, such as that provided in Tables 8a, 8b, 8c, 8d, a composition may be provided with a viscosity of about 400,000 cP.

Notably, compositions with a viscosity ranging from 150,000 cP to 350,000 cP (and any range or value there between) (see Table 5), or from 300,000 cP to about 500,000 cP (and any range or value there between) (see Tables 8a, 8b, 8c, 8d), or with a viscosity of about 400,000 cP (see Tables 8a, 8b, 8c, 8d) are sprayable by airless spray equipment. A person having ordinary skill in the art would conventionally believe this viscosity to be too viscous for spraying by airless spray equipment and would believe the art would teach away from such application mechanisms. In various embodiments, such airless spray equipment suitable for products with viscosities greater than 300,000 cP may include, for example, an airless sprayer capable of 2800 psi (19.31 MPa) or greater (and any range or value there between). In various embodiments, such airless spray equipment may include nozzle orifice size between 0.015 and 0.017 inches (and any range or value there between) for optimum balance of coverage or bead size to maximize usage from a five gallon pail, but can be sprayed with a larger nozzle orifice size if greater (thicker) coverage or bead size is needed.

However, it has been unexpectedly determined that airless sprayers such as commercial paint sprayers are able to spray such compositions. Typically, such high viscosity sealants would be difficult or impossible to spray with airless spray equipment, however, the ability of the microspheres to collapse and rebound facilitates spray application of such high viscosity sealants.

Moreover, such compositions may be provided in foil packs, in buckets, such as five gallon buckets, and may be applied by bulk caulking gun. One would expect that a sprayable sealant would not have the rheology or viscosity for filling into a bulk caulking gun and applying as a caulk sealant. As such, the conventional art teaches away from a mechanism of application such as a bulk caulking gun. However, it has been unexpected determined that again, the rheology and low product density resultant from the microspheres facilitates drawing of such high viscosity sealants from a bucket into a bulk caulking gun.

The ease of drawing of such sealants into the bulk chaulking gun as compared to conventional caulk sealants makes repetitive use less strenuous for the job site construction workers. For instance, a follow-plate may be placed inside the pail on top of the sealant and the bulk gun is attached. The sealant is suctioned into the bulk gun by pulling back the lever. Once filled, the bulk gun is detached, and the nozzle is screwed on. Then the product can be applied. The rheology and low product density that the addition of the microspheres creates at this range of viscosity makes the product easy to load into a bulk gun.

For further helpful context, it is explained that cP and KU are both measurements of dynamic viscosity and may both be discussed with reference to embodiments herein. Dynamic viscosity is the resistance of the viscous fluid to flow. Krebs Units (KU) is a measurement of dynamic velocity measured on a Stormer Viscometer according to ASTM D562. Centipoise is a measurement of dynamic velocity defined by shear. KU is measured according to ASTM D562, which is incorporated by reference herein. For example, KU corresponds to a load in grams required to produce a rotational frequency of 200 r/min for an offset paddle rotor immersed in a fluid to be measured. The offset paddle apparatus is called a Stormer Viscometer. Krebs Units can also be measured by measuring the reaction torque of a spindle rotated at 200 rpm by a motor. Modern Stormer viscometers measure both Krebs Units and cP. Modern Stormer viscometers have a standard measure range of 40 KU-141 KU, 32 gm-1099 gm, and 27 cP-5274 cP. Stormer viscometers are also calibrated with oils that are calibrated in cP. Due to the modern Stormer Viscometers capability to read in both KU and cP units for a given sample and the use of calibration oils in cP, a strong correlation can be concluded between KU and cP. For example, a Stormer viscometer may measure in both KU and cP units and the units may be related according to a chart, such as provided below:

| Centipoise (cP) | Krebs Units (KU) |
|---|---|
| 1300 | 95 |
| 1700 | 101 |
| 2300 | 105 |
| 2500 | 114 |
| 400,000 | Beyond Stormer Viscometer ability |
| | to test in Krebs Units or cP. |

As can be seen from the discussion above, the formulations are relatively viscous, some even exceeding the measurement capability of Krebs Units, yet still sprayable due to the high compressibility of the microspheres.

Continuing the discussion of Tables 8a, 8b, 8c, and 8d, Tables 8a, 8b, 8c, and 8d show example formulas for a product with the high loading level of surfactant, discussed herein, and having a density from about 0.77 g/cm³ to about 0.92 g/cm³ (and any range or value there between), or in some embodiments, having a density from about 0.84 g/cm³ to about 0.85 g/cm³ (and any range or value there between), or having a density of about 0.82 g/cm³, or having other densities that may be desired. This product is an acoustic mastic, meaning that it is able to dampen noise transmission. This formula is an aqueous formulation. This formula is capable of significant compression and rebound. For example, in various embodiments, the material, cured and placed in a closed walled container and compressed, may have from about 28% to about 48% (and any range or value there between) of compression in the cured state. In further instances, the material, cured in a bead form and compressed, may have from about 50% to about 85% (and any range or value there between) of compression in the cured state, and in various instances, may be capable of over 85% compression in the cured state. In various instances, formulations of lower density exhibit greater compressibility.

This formula exhibits an ASTM E 90 STC rating of 63 and an OITC rating of 53. This formula meets ASTM C-834 Standard Specifications for Latex Sealants, Type OP, Grade 0° C., which includes ASTM C-732 Standard Test Method for Aging Effects of Artificial Weathering on Latex Sealants, ASTM C-734 Standard Test Method for Low-Temperature Flexibility of Latex Sealants After Artificial Weathering, ASTM C-736 Standard Test Method For Extension and Adhesion of Latex Sealants, ASTM C-1183 Standard Test Method for Extrusion Rate of Elastomeric Sealants, ASTM C-1241 Standard Test Method for Volume Shrinkage of Latex Sealants During Cure, ASTM D-2202 Standard Test Method for Slump of Sealants, ASTM D-2203 Standard Test Method for Staining from Sealants, ASTM D-2377 Standard Test Method for Tack-Free Time of Caulking Compounds and Sealants, ASTM G 21 Standard Practice for Determining Resistance of Synthetic Polymeric Materials to Fungi, and ASTM E84 Standard Test Method for Surface Burning Characteristics. This formula exhibits a movement capability of 12.5%.

In various embodiments, this formulation is paintable. Typical substrates may include glass, gypsum, wood, aluminum, and basic wall construction materials. It is compatible with CPVC pipes. Moreover, the low density allows for improved ergonomics on the job site for carrying 5 gallon pails and cases of foil packs.

Moreover, the formulation disclosed in Tables 8a, 8b, 8c, 8d differ in important ways from the formulas discussed in Tables 2-7. For example, these formulas have been designed to have a balance between polymer amounts, choice of polymer types, and amount of microspheres needed to meet ASTM C-834 performance with a low VOC content, compatibility with CPVC and the ability to be painted without softening and without altering the color or sheen/gloss of the paint. Moreover, this formulation exhibits a shelf life of 24 months. These formulations have the highest amount of surfactant (wetting agent), in contrast to the Tables 2-7 formulations, to achieve this goal. Typical loading levels of surfactant (from about 0.2 to about 0.5 weight percent) would not allow the formulations to mix without coagulating into an unusable mass due, at least in part, to the organic microsphere shell. Increasing the surfactant (wetting agent) well above the normal loading level would conventionally cause other issues that would render the sealant unusable and as discussed herein. Wetting agents in waterborne sealants promote the formation and stabilization of microfoam thus preventing microfoam bubbles within the sealant from coalescing which would hinder their ability to rise to the surface. This could lead to craters, pinholes, or fisheyes caused by the macrofoam and microfoam during curing. High loading levels of surfactant could lead to poor adhesion, poor performance, poor moisture resistance, increased foaming, interference with associative thickeners impacting formulation rheology and poor drying of the composition. Over saturation with surfactants can also lead to surfactant leaching (also known as weeping) leaving a sticky, oily, soapy or sap-like substance on the surface of the film or causing irregular surface discoloration, especially in high heat and humidity conditions. Surfactant leaching could hinder the sealant unpaintable. However, and as discussed above, numerous unexpected results contribute unexpectedly to highly usable formulations without the conventionally expected surfactant-related problems.

To reach a shelf life of 24 months, surfactant (wetting agent) was elevated to about 1.1 to about 2.0 weight percent, and in various instances, about 1.49 or greater weight percent, a conventionally excessive amount for any typical formulation. Because increasing the surfactant (wetting agent) may lead to increased macrofoam and microfoam formation within the wet state of the sealant, the defoamer chosen for this formulation is a hyper branched polymer that is essentially emission-free. This defoamer provides high efficiency, persistency, fast bubble break times, and is effective against microfoam. Because of the high usage of wetting agent, a high efficiency defoamer is implemented to achieve a tight film during curing to prevent defects such as pinholing and formation of gas pockets in the film. Gas pockets can lead to fracture points that could lead to performance failures. Using a high efficiency defoamer allows lower usage amounts than typical mineral oil defoamers. Lower amounts of defoamer eliminates potential risks associated with adding a high amount of defoamer such as interfering with adhesion to the substrate. Use of a vacuum during the mixing process also facilitates adequate defoaming.

Other important aspects facilitate achieving the ASTM C-834 performance goal. For instance, the Tables 8a, 8b, 8c, 8d formulation avoids any use of a plasticizer. Consequently Tables 8a, 8b, 8c, 8d reflect a formulation that will not stain from plasticizer leaching and which passes ASTM D2203 Test Method for Staining from Sealants, part of ASTM C-834 Standard Specification for Latex Sealants. Additionally this allows the formulation to be paintable without plasticizer migration issues that would cause the color or sheen of the paint to alter over time. Moreover, Tables 8a, 8b, 8c, 8d reflect selection of polymers that balance competing Tg-related objectives. The selected polymers combined have one polymer with sufficiently low Tg to facilitate elongation and one polymer with sufficiently high Tg to ensure recovery after elongation and resistance to deformation at elevated temperatures to meet the performance requirements of ASTM C-834 Standard Specification for Latex Sealants, most particularly ASTM C-736 Standard Test Method for Extension-Recovery and Adhesion of Latex Sealants. For instance, Acronal V-278 and DR6152 (also called Ligos C9504) may be used in combination. In various embodiments Acronal V-278 has a low Tg of −35 degrees C. The polymer with the higher Tg may go to a higher number if more heat resistance is desired for a formulation. Acronal V-278 may, if used alone, result in a product with softness inhibiting full recover after extension. Consequently, the introduction of a stiffer polymer with a higher Tg facilitates adequate extension recovery. In various instances, the combination of Acronal V-278 and DR6152 facilitates satisfaction of ASTM C736 which is part of ASTM C834. In contrast, DR6152 (Ligos C9504) may, if used alone, result in a product with stiffness inhibiting low temperature flexibility. Consequently, combination with the softer Acronal V-278 may facilitate adequate low temperature flexibility. In various instances, the combination of Acronal V-278 and DR6152 facilitates satisfaction of ASTM C734 which as a part of ASTM C834.

The formulations in Tables 8a, 8b, 8c, 8d target a correct amount of microspheres to avoid exceeding the CPVC (critical pigment volume concentration). The microspheres are formulated for stability as an organic polymer, but impact the CPVC similar to an inorganic filler. There is a point that the formulation reaches its maximum loading level while still having enough binder to fill the space around the particles, which may be large spherical particles, to maintain extension/recovery of a minimum. In various instances, the minimum extension/recovery may be about 12.5%.

Other additives are selected to fine tune performance characteristics needed to meet ASTM C-834 specifications. Kaolin clay is selected to boost the cohesive strength of the formulation which also helps to offset the effect the extremely large microspheres has on the cohesive strength. The kaolin clay may provide titanium dioxide (TiO₂) extension. TiO₂ is added to pigment (whiten) the formulation. KTPP is added to deflocculate the kaolin clay to help stabilize the viscosity. The adhesion to glass needed to pass ASTM C-736 is enhanced by addition of Silquest A-186. Addition of Silquest A-186 also increases the moisture resistance of the sealant which otherwise could be compromised by the high level of surfactant (wetting agent) and, combined with the addition of the kaolin clay, the Silquest A-186 contributes to increasing the cohesive strength of the formulation through hydrogen bonding to pass ASTM C-834. In various embodiments, one may appreciate that various aspects perform multiple functions. For example, Silquest A-186, may be a coupling agent, and adhesion promotor, such as to improve adhesion to surfaces, glass, etc., and may further enhance moisture resistance such as to pass ASTM-C834. Aluminum trihydrate is added to satisfy ASTM E84. The Tamol 851 dispersant is added to disperse and stabilize the fillers by steric stabilization. The Polyphase 678 biocide was chosen as a wide spectrum dry film protectant to prevent mold growth during the products service life. The Mergal 758 was chosen as an in-can preservative to prevent spoilage of the stored material prior to use for the length of the shelf life. Monopropylene glycol was chosen as the freeze thaw agent to avoid using known hazardous air pollutant freeze thaw agents such as ethylene glycol or methanol. The alkali swellable (ASE) thickener (such as, P-1172) is added for increasing the viscosity of the formulation and imparting a pseudoplastic rheology to prevent slumping in vertical application such as filling wall penetrations or gaps or cracks or seams, particularly when applications are approximately 0.5 inches wide. The ammonium hydroxide modifies the pH to activate the thickener and help stabilize the formulation. The water added as the diluent must be at a sufficient level to allow for stabilization to prevent premature film formation by acting with hydrophilic vs hydrophobic intermolecular forces such that, for example, keeping the individual micelles of filler and binder from coalescing.

The microspheres, for instance, Expancel® microspheres such as Expancel MI90 DET 80 d15 microspheres, are added to greatly lower the density of the formulation and provide other material properties discussed elsewhere herein. This reduction in density allows ergonomic advantage for job site construction workers who are tasked with carrying and using the finished product. For example, a typical product used for acoustical and smoke penetrations will weigh between 60 to 80 lbs (27.2 to 36.3 kg) in a 5-gallon pail. In contrast, the Tables 8a, 8b, 8c, 8d formulation will weigh approximately 37 lbs (16.8 kg) in a 5-gallon pail. Unions that require workers to limit the amount of weight carried to under 50 lbs (22.7 kg) to avoid injuries would benefit from a low density ASTM C-834 sealant.

The microspheres impart a creamy, light texture to the product. The lightweight nature and rheological benefits allow the product to be tooled easier than typical sealants. The collapsible and rebound properties of the Expancel® microspheres, such as Expancel MI90 DET 80 d15 and/or Expancel 909 DET 80 d15, allows for additional benefits beyond a typical acoustical or smoke sealant such as sprayability, and gasketing, in addition to exhibiting excellent acoustical properties.

Spray application saves time at a job site as well as facilitates penetration deeper into crevices for a better seal. Moreover, a bead can be formed during spraying. For instance, a bead may be formed by holding the base guard of the nozzle tip against the substrate and lining up the spray from the nozzle along the crevices that needs to be sealed and running the bead all the way across the crevice while spraying. This is a much faster application method than using a cartridge tube. If the product is used in an area of a construction site such as a top plate that will then be covered with a substrate that is easily breakable, such as drywall, the microspheres will collapse, and the sealant will behave as a gasket instead of causing the drywall to break as would a rigid sealant bead.

TABLE 8a

| Raw Material | | % | % |
|---|---|---|---|
| Category | Raw Material | Weight | Volume |
| Styrenated Acrylic | DR 6152 (LIGOS | 38.153 | 30.646 |
| Polymer | 9504) | | |
| Acrylate-Acrylonitrile | Acronal V-278 | 17.254 | 13.529 |
| Copolymer | | | |
| Diluent | Water | 9.396 | 7.745 |
| Defoamer | Foamstar 2420 | 0.097 | 0.093 |
| Surfactant | Zetasperse 179 | 1.485 | 1.223 |
| Biocide | Polyphase 678 | 0.097 | 0.067 |
| Biocide | Mergal 758 | 0.193 | 0.150 |
| Freeze/Thaw Additive | MonoPropylene | 0.965 | 0.765 |
| | Glycol | | |
| Dispersant | Tamol 851 | 0.821 | 0.563 |
| Functional Filler | Titanium Dioxide | 0.821 | 0.176 |
| Microspheres | Expancel 909 DET 80 | 0.637 | 33.388 |
| | d15 (or Expancel MI | | |
| | 90 DET 80 d15) | | |
| Secondary Dispersant | KTPP | 0.267 | 0.190 |
| Kaolin Clay | ASP-170 | 3.668 | 1.170 |
| Adhesion Promoter/ | Silquest A-186 | 0.100 | 0.077 |
| Coupling Agent | | | |
| Functional Filler/Smoke | Aluminum Trihydrate | 23.286 | 7.998 |
| and Flame Retardant | SB432 | | |
| ASE Thickener | Thickener P1172 | 2.109 | 1.625 |
| pH Modifier | Ammonium Hydroxide | 0.653 | 0.598 |

Table 8a illustrates precise measurements of percent weight and percent volume of different ingredients. However, in various embodiments, the ingredients may be provided within a range of percent weight and percent volume and various desirable properties of the composition still be exhibited thereby. Moreover one may appreciate that the formula of table 8a may be estimated to two significant digits.

TABLE 8b

| Raw Material | | % | % |
|---|---|---|---|
| Category | Raw Material | Weight | Volume |
| Styrenated Acrylic | DR 6152 (LIGOS | 38.415 | 30.696 |
| Polymer | 9504) | | |
| Acrylate-Acrylonitrile | Acronal V-278 | 15.286 | 11.924 |
| Copolymer | | | |
| Diluent | Water | 10.085 | 8.270 |
| Defoamer | Foamstar 2420 | 0.099 | 0.095 |
| Surfactant | Zetasperse 179 | 1.527 | 1.160 |
| Biocide | Polyphase 678 | 0.099 | 0.068 |
| Biocide | Mergal 758 | 0.199 | 0.154 |
| Freeze/Thaw Additive | MonoPropylene | 0.993 | 0.783 |
| | Glycol | | |
| Dispersant | Tamol 851 | 0.844 | 0.576 |
| Functional Filler | Titanium Dioxide | 0.844 | 0.180 |
| Microspheres | Expancel 909 DET 80 | 0.655 | 34.155 |
| | d15 (or Expancel MI | | |
| | 90 DET 80 d15) | | |
| Secondary Dispersant | KTPP | 0.275 | 0.194 |
| Kaolin Clay | ASP-170 | 3.772 | 1.197 |
| Adhesion Promoter/ | Silquest A-186 | 0.122 | 0.094 |
| Coupling Agent | | | |
| Functional Filler/Smoke | Aluminum Trihydrate | 23.945 | 8.182 |
| and Flame Retardant | SB432 | | |
| ASE Thickener | Thickener P1172 | 2.169 | 1.662 |
| pH Modifier | Ammonium Hydroxide | 0.672 | 0.611 |

Table 8b illustrates precise measurements of percent weight and percent volume of different ingredients. However, in various embodiments, the ingredients may be provided within a range of percent weight and percent volume and various desirable properties of the composition still be exhibited thereby. Moreover one may appreciate that the formula of table 8b may be estimated to two significant digits.

TABLE 8c

| Raw Material | | % | % |
|---|---|---|---|
| Category | Raw Material | Weight | Volume |
| Styrenated Acrylic | DR 6152 (LIGOS | 39.271 | 31.255 |
| Polymer | 9504) | | |
| Acrylate-Acrylonitrile | Acronal V-278 | 15.627 | 12.141 |
| Copolymer | | | |
| Diluent | Water | 8.081 | 6.601 |
| Defoamer | Foamstar 2420 | 0.102 | 0.096 |
| Surfactant | Zetasperse 179 | 1.561 | 1.181 |
| Biocide | Polyphase 678 | 0.102 | 0.069 |
| Biocide | Mergal 758 | 0.203 | 0.156 |
| Freeze/Thaw Additive | MonoPropylene | 1.015 | 0.797 |
| | Glycol | | |
| Dispersant | Tamol 851 | 0.863 | 0.587 |
| Functional Filler | Titanium Dioxide | 0.863 | 0.183 |
| Microspheres | Expancel 909 DET 80 | 0.670 | 34.777 |
| | d15 (or Expancel MI | | |
| | 90 DET 80 d15) | | |
| Secondary Dispersant | KTPP | 0.281 | 0.198 |
| Kaolin Clay | ASP-170 | 3.856 | 1.218 |
| Adhesion Promoter/ | Silquest A-186 | 0.125 | 0.095 |
| Coupling Agent | | | |
| Functional Filler/Smoke | Aluminum Trihydrate | 24.479 | 8.331 |
| and Flame Retardant | SB432 | | |
| ASE Thickener | Thickener P1172 | 2.217 | 1.692 |
| pH Modifier | Ammonium Hydroxide | 0.687 | 0.623 |

Table 8c illustrates precise measurements of percent weight and percent volume of different ingredients. However, in various embodiments, the ingredients may be provided within a range of percent weight and percent volume and various desirable properties of the composition still be exhibited thereby. Moreover one may appreciate that the formula of table 8c may be estimated to two significant digits.

One example embodiment of the Tables 8a, 8b, and 8c composition is illustrated in Table 8d below which reflects that the ingredients may be provided within a range of percent weight and percent volume and various desirable properties of the composition still be exhibited thereby:

TABLE 8d

| | | % | % |
|---|---|---|---|
| Raw Material | | Weight | Volume |
| Category | Raw Material | Range | Range |
| Styrenated Acrylic | DR 6152 (LIGOS | (36.4-40.4) | (29.9-33.6) |
| Polymer | 9504) | | |
| Acrylate- | Acronal V-278 | (13.3-18.4) | (11.1-14.9) |
| Acrylonitrile | | | |
| Copolymer | | | |
| Diluent | Water | (3.9-12.0) | (3.3-10.2) |
| Defoamer | Foamstar 2420 | (0.04-0.3) | (0.04-0.3) |
| Surfactant | Zetasperse 179 | (1.1-2.0) | (0.9-1.7) |
| Biocide | Polyphase 678 | (0.04-0.5) | (0.03-0.4) |
| Biocide | Mergal 758 | (0.04-0.5) | (0.03-0.4) |
| Freeze/Thaw | MonoPropylene | (0.7-1.5) | (0.6-1.2) |
| Additive | Glycol | | |
| Dispersant | Tamol 851 | (0.6-1.4) | (0.4-1.0) |
| Functional Filler | Titanium Dioxide | (0.0-2.0) | (0.0-0.5) |
| Microspheres | Expancel 909 DET | (0.4-1.0) | (29.0-40.0) |
| | 80 d15 (or Expancel | | |
| | MI 90 DET 80 d15) | | |
| Secondary | KTPP | (0.06-0.4) | (0.04-0.3) |
| Dispersant | | | |
| Kaolin Clay | ASP-170 | (2.0-5.0) | (0.6-1.7) |
| Adhesion Promoter/ | Silquest A-186 | (0.07-0.3) | (0.09-0.2) |
| Coupling Agent | | | |
| Functional Filler/ | Aluminum | (21.0-26.0) | (7.3-9.4) |
| Smoke and Flame | Trihydrate | | |
| Retardant | SB432 | | |
| ASE Thickener | Thickener 1172 | (0.7-4.0) | (0.5-3.2) |
| pH Modifier | Ammonium Hydroxide | (0.3-1.1) | (0.2-1.0) |

Thus, referring to the combination of Tables 8a, 8b, 8c, and 8d, one may appreciate that various embodiments of the compositions with various specific amounts of the ingredients are possible. Examples provided in Tables 8a, 8b, and 8c all reflect amounts within the ranges provided in Table 8d.

In various embodiments, the composition includes a styrenated acrylic polymer. For instance, DR 6152 (LIGOS 9504) may be included. The styrenated acrylic polymer may be provided in amounts including 38.153 weight percent, 38.415 weight percent, and/or 39.271 weight percent. The styrenated acrylic polymer may be provided in any weight percent from about 36.4 to about 40.4 weight percent (and any range or value there between). The styrenated acrylic polymer may be provided in amounts including 30.646 volume percent, 30.696 volume percent, and/or 31.255 volume percent. The styrenated acrylic polymer may be provided in any volume percent from about 29.9 volume percent to about 33.6 volume percent (and any range or value there between).

In various embodiments, the composition includes an acrylate-acrylonitrile copolymer. For instance, Acronal V-278 may be included. The acrylate-acrylonitrile copolymer may be provided in amounts including 17.254 weight percent, 15.286 weight percent, and/or 15.627 weight percent. The acrylate-acrylonitrile copolymer may be provided in any weight percent from about 13.3 weight percent to about 18.4 weight percent (and any range or value there between). The acrylate-acrylonitrile copolymer may be provided in amounts including 13.529 volume percent, 11.924 volume percent, and/or 12.141 volume percent. The acrylate-acrylonitrile copolymer may be provided in any volume percent from about 11.1 volume percent to about 14.9 volume percent (and any range or value there between).

In various embodiments, the composition includes a diluent. For instance, water may be included. The diluent may be provided in amounts including 9.396 weight percent, 10.085 weight percent, and/or 8.081 weight percent. The diluent may be provided in any weight percent from about 3.9 weight percent to about 12.0 weight percent (and any range or value there between). The diluent may be provided in amounts including 7.745 volume percent, 8.270 volume percent, and/or 6.601 volume percent. The diluent may be provided in any volume percent from about 3.3 volume percent to about 10.2 volume percent (and any range or value there between).

In various embodiments, the composition includes a defoamer. For instance, Foamstar 2420 may be included. The defoamer may be provided in amounts including 0.097 weight percent, 0.099 weight percent, and/or 0.102 weight percent. The defoamer may be provided in any weight percent from about 0.04 weight percent to about 0.3 weight percent (and any range or value there between). The defoamer may be provided in amounts including 0.093 volume percent, 0.095 volume percent, and/or 0.096 volume percent. The defoamer may be provided in any volume percent from about 0.04 volume percent to about 0.3 volume percent (and any range or value there between).

In various embodiments, the composition includes a surfactant. For example, Zetasperse 179 may be included. The surfactant may be provided in amounts including 1.485 weight percent, 1.527 weight percent, and/or 1.561 weight percent. The surfactant may be provided in any weight percent from about 1.1 weight percent to about 2.0 weight percent (and any range or value there between). The surfactant may be provided in amounts including 1.223 volume percent, 1.160 volume percent, and/or 1.181 volume percent. The surfactant may be provided in any volume percent from about 0.9 volume percent to about 1.7 volume percent (and any range or value there between).

In various embodiments, the composition includes a first biocide. The first biocide may be Polyphase 678. The first biocide may be provided in amounts including 0.097 weight percent, 0.099 weight percent, and/or 0.102 weight percent. The first biocide may be provided in amounts ranging from about 0.04 weight percent to about 0.5 weight percent (and any range or value there between). The first biocide may be provided in amounts including 0.067 volume percent, 0.068 volume percent, and/or 0.069 volume percent. The first biocide may be provided in any volume percent from about 0.03 volume percent to about 0.4 volume percent (and any range or value there between).

In various embodiments, the composition includes a second biocide. The second biocide may be Mergal 758. The second biocide may be provided in amounts including 0.193 weight percent, 0.199 weight percent, and/or 0.203 weight percent. The second biocide may be provided in amounts ranging from about 0.04 weight percent to about 0.5 weight percent (and any range or value there between). The second biocide may be provided in amounts including 0.150 volume percent, 0.154 volume percent, and/or 0.156 volume percent. The second biocide may be provided in any volume percent from about 0.03 volume percent to about 0.4 volume percent (and any range or value there between).

In various embodiments, the composition includes a freeze/thaw additive. The freeze/thaw additive may be monopropylene glycol. The freeze/thaw additive may be provided in amounts including 0.965 weight percent, 0.993 weight percent, and/or 1.015 weight percent. The freeze/thaw additive may be provided in any amount ranging from about 0.7 weight percent to about 1.5 weight percent (and any range or value there between). The freeze/thaw additive may be provided in amounts including 0.765 volume percent, 0.783 volume percent, and/or 0.797 volume percent. The freeze/thaw additive may be provided in any amount ranging from about 0.6 volume percent to about 1.2 volume percent (and any range or value there between).

In various embodiments, the composition includes a dispersant. The dispersant may be Tamol 851. The dispersant may be provided in amounts including 0.821 weight percent, 0.844 weight percent, and/or 0.863 weight percent. The dispersant may be provided in any amount ranging from about 0.6 weight percent to about 1.4 weight percent (and any range or value there between). The dispersant may be provided in amounts including 0.563 volume percent, 0.576 volume percent, and/or 0.587 volume percent. The dispersant may be provided in any amount ranging from about 0.4 volume percent to about 1.0 volume percent (and any range or value there between).

In various embodiments, the composition includes a functional filler. The functional filler may be titanium dioxide. The functional filler may be provided in amounts including 0.821 weight percent, 0.844 weight percent, and/or 0.863 weight percent. The functional filler may be provided in any amount ranging from about 0.0 weight percent to about 2.0 weight percent (and any range or value there between). The functional filler may be provided in amounts including 0.176 volume percent, 0.180 volume percent, and/or 0.183 volume percent. The functional filler may be provided in any amount ranging from about 0.0 volume percent to about 0.5 volume percent (and any range or value there between).

In various embodiments, the composition includes microspheres. The microspheres may comprise Expancel® microspheres. The microspheres may comprise Expancel® MI 90 DET 80 d15 microspheres. The microspheres may comprise Expancel® 909 DET 80 d15 microspheres. The microspheres may be provided in amounts including 0.637 weight percent, 0.655 weight percent, and/or 0.670 weight percent. The microspheres may be provided in any amount ranging from about 0.4 to about 1.0 weight percent (and any range or value there between). The microspheres may be provided in amounts including 33.388 volume percent, 34.155 volume percent, and/or 34.777 volume percent. The microspheres may be provided in any amount ranging from about 29.0 volume percent to about 40.0 volume percent (and any range or value there between).

In various embodiments, the composition includes a secondary dispersant. The secondary dispersant may be KTPP. The secondary dispersant may be provided in amounts including 0.267 weight percent, 0.275 weight percent, and/or 0.281 weight percent. The secondary dispersant may be provided in any amount ranging from about 0.06 weight percent to about 0.4 weight percent (and any range or value there between). The secondary dispersant may be provided in amounts including 0.190 volume percent, 0.194 volume percent, and/or 0.198 volume percent. The secondary dispersant may be provided in any amount ranging from about 0.04 to about 0.3 volume percent (and any range or value there between).

In various embodiments, the composition includes kaolin clay. The kaolin clay may be ASP-170. The kaolin clay may be provided in amounts including 3.668 weight percent, 3.772 weight percent, and/or 3.856 weight percent. The kaolin clay may be provided in any amount ranging from about 2.0 to about 5.0 weight percent (and any range or value there between). The kaolin clay may be provided in amounts including 1.170 volume percent, 1.197 volume percent, and/or 1.218 volume percent. The kaolin clay may be provided in any amount ranging from about 0.6 volume percent to about 1.7 volume percent (and any range or value there between).

In various embodiments, the composition includes an adhesion promoter/coupling agent. The adhesion promoter/coupling agent may be Silquest A-186. The adhesion promoter/coupling agent may be provided in amounts including 0.100 weight percent, 0.122 weight percent, and/or 0.125 weight percent. The adhesion promoter/coupling agent may be provided in any amount ranging from about 0.07 weight percent to about 0.3 weight percent (and any range or value there between). In various embodiments, the adhesion promoter/coupling agent may be provided in amounts including 0.077 volume percent, 0.094 volume percent, and/or 0.095 volume percent. The adhesion promoter/coupling agent may be provided in any amount ranging from about 0.09 volume percent to about 0.2 volume percent (and any range or value there between).

In various embodiments, the composition includes a functional filler/smoke and flame retardant. The functional filler/smoke and flame retardant may be aluminum trihydrate SB432. The functional filler/smoke and flame retardant may be provided in amounts including 23.286 weight percent, 23.945 weight percent, and/or 24.479 weight percent. The functional filler/smoke and flame retardant may be provided in any amount ranging from about 21.0 to about 26.0 weight percent (and any range or value there between). The functional filler/smoke and flame retardant may be provided in amounts including 7.998 volume percent, 8.182 volume percent, and/or 8.331 volume percent. The functional filler/smoke and flame retardant may be provided in any amount ranging from about 7.3 volume percent to about 9.4 volume percent (and any range or value there between).

In various embodiments, the composition includes an ASE thickener. The ASE thickener may be Thickener P1172. The ASE thickener may be provided in amounts including 2.109 weight percent, 2.169 weight percent, and/or 2.217 weight percent. The ASE thickener may be provided in any amount ranging from about 0.7 weight percent to about 4.0 weight percent (and any range or value there between). The ASE thickener may be provided in amounts including 1.625 volume percent, 1.662 volume percent, and/or 1.692 volume percent. The ASE thickener may be provided in any amount ranging from about 0.5 volume percent to about 3.2 volume percent (and any range or value there between).

In various embodiments, the composition includes a pH modifier. The pH modifier may be ammonium hydroxide. The pH modifier may be provided in amounts including 0.653 weight percent, 0.672 weight percent, and/or 0.687 weight percent. The pH modifier may be provided in any amount ranging from about 0.3 weight percent to about 1.1 weight percent (and any range or value there between). The pH modifier may be provided in amounts including 0.598 volume percent, 0.612 volume percent, and/or 0.623 volume percent. The pH modifier may be provided in any amount ranging from about 0.2 volume percent to about 1.0 volume percent (and any range or value there between).

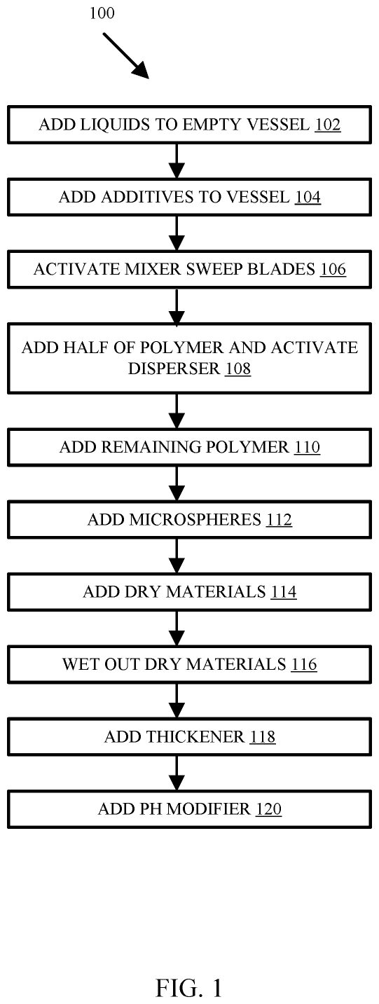

FIG. 1 provides a flowchart 100 illustrating an example method for producing compositions disclosed herein. At 102, the liquids are added to an empty vessel. Such liquids may include, for example: water, surfactant, dispersant, defoamer, and biocides. At 104, any additives are added to the vessel. Such additives may include, for example: anti-freeze agent, dye or pigments, plasticizer, coalescing agents, or any other additives discussed herein. At 106, the mixing apparatus (e.g., mixer sweep blades and/or disperser) is activated. In some embodiments, a vacuum is activated if the polymer is dosed using a vacuum to pull the material into the vessel. The vacuum dissipates as the polymer is loaded. Otherwise, the polymer is dosed from a weigh hopper into the vessel.

At 108, the polymer is added to the mix until about half of the polymer is dosed, then a disperser is activated. In various embodiments, the disperser includes sweep blades in the mixing vessel and/or planetary blades in the mixing vessel. At 110, the remaining polymer is dosed and the vacuum is activated (or reactivated) to approximately 28 in Hg and held until mixing of the liquid materials is complete. The vacuum is released. At 112, the microspheres are added to the mixture. In some embodiments, this is achieved by using a weigh hopper filled with microspheres. The weigh hopper is on load cells that show the total weight. The microspheres are loaded into the mixer by loss of weight (that is, by subtracting the required weight in the formulation from the total weight in the hopper) and using a peristaltic pump to dose the microspheres into mixer. Once the dosing is complete, the peristaltic pump is deactivated and the pump valves at the hopper and mixer are closed. Due to their light-weight nature, the microspheres will form a cloud in the head space of the vessel. In some embodiments, the microspheres are dosed using a closed system to avoid contact with an irritating microsphere dust cloud. After the microspheres are dosed and allowed to settle, a vacuum is turned on, then the mixing apparatus (such as mixer sweep blades and/or disperser) to mix the microspheres into the liquid medium.

Once the microspheres are substantially clear from the head space and mixed into the liquids, the vacuum vent is released, the mixing apparatus (such as mixer sweep blades and/or disperser) is deactivated, and any residual microspheres floating in the head space are allowed to settle and stick to the liquid surface. Then the mixing apparatus (such as mixer sweep blades and/or disperser) is activated and the dry materials are added at 114. Examples of such dry materials may include: fillers such as mica, aluminum trihydrate, kaolin clay, magnesium hydroxide, aluminum phosphate, aluminum polyphosphate, fillite, calcium carbonate, talc, silica, or others or a combination of some depending on final product performance properties.

At 116, a vacuum is generated to wet out the dry materials as the product mixes and aid in removing macrofoam and microfoam. In some embodiments, this process causes the product to rise in the mixer. If the product rises beyond a desired level, the vacuum may be released and reactivated as needed. In some embodiments, the product is mixed for approximately ten minutes.

At 118, the vacuum is released and the thickener is added to the mixture while the mixing apparatus (such as mixer sweep blades and/or disperser) is running. At 120, the pH modifier is added, the mixer is closed and a vacuum is generated for approximately fifteen to twenty minutes to ensure, for example, that the product is free of undispersed filler agglomerates, that the thickener has unraveled, and/or that the product is deaerated for improved film formation in the finished product. In some embodiments, the thickener, water, and/or pH modifier may be adjusted as needed.

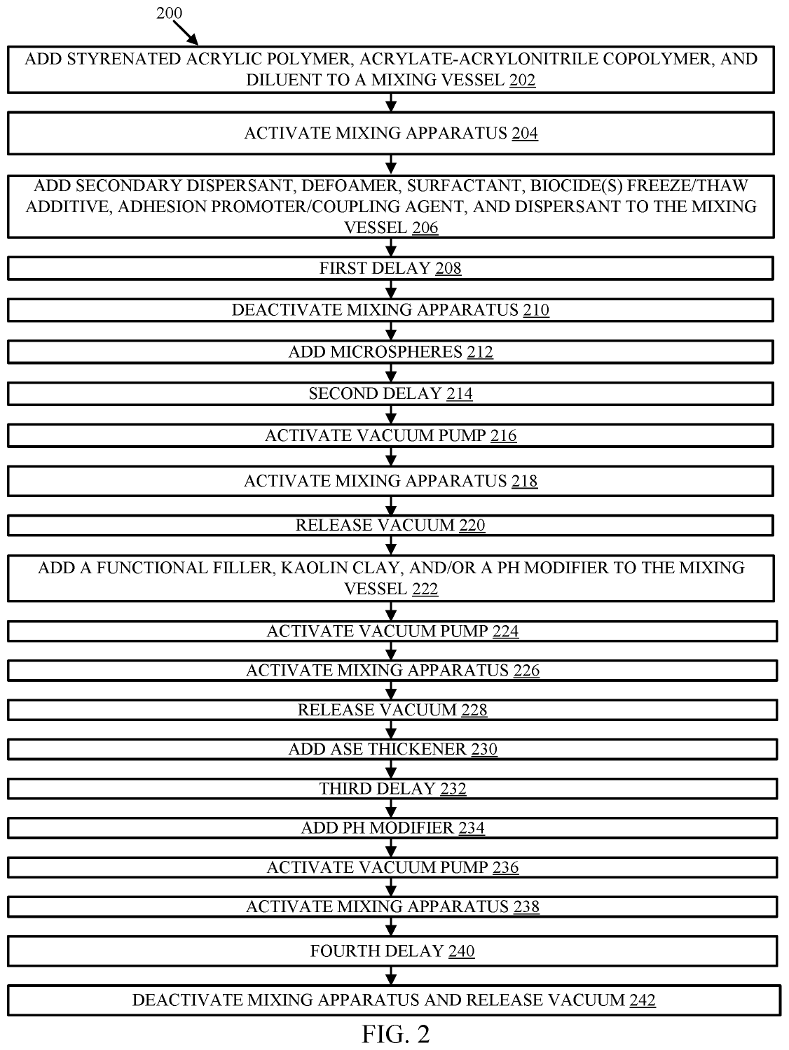

Directing attention to FIG. 2, a flowchart 200 is provided illustrating a further method of producing the composition. Moreover, specific reference is also made to the composition of Tables 8a, 8b, 8c, and 8d. In various embodiments, incorporating the large, lightweight microspheres into the formulation presents particular challenges. For example, the microspheres may tend to float buoyantly and be easily disturbed by air currents. Despite increasing buoyancy under a vacuum, removing the air from the mixing vessel allows the lightweight spheres to wet out considerably faster as they come in contact with the liquid-sphere interface to expedite the mixing process to prevent over-mixing that could lead to heat build-up and effect the polymer's stability. Consequently, aspects of the method of producing the composition occur under vacuum conditions. Moreover, aspects occur within a closed vessel to prevent the microspheres from becoming airborne. Airborne microspheres may behave much like dust particles. However, airborne microspheres are highly irritating and may become a potential dust explosion hazard if not adequately controlled and contained.

Unlike smaller and heavier microspheres, the microspheres discussed herein with a density range of about 12 to about 18 kg/m³ (about 0.012 to about 0.018 g/cm3) (and any range or value there between) and a diameter range of about 60 to about 90 microns (and any range or value there between), for instance, certain Expancel® microspheres, are particularly susceptible to floating buoyantly and being easily disturbed by air currents. For instance, they may tend to float suspended in the atmosphere similar to dust particles. After the microspheres are added to the mixing vessel, time must be allowed to let the microspheres settle. Once the head space in the closed mixing vessel is clear of substantially all unsettled microspheres, a vacuum is then turned on and allowed to reach about 25 in Hg (about 635 mm Hg) before any mixing apparatus (such as disperser and/or mixer sweep blades) is turned on.

The vacuum will facilitate the microspheres remaining in close contact with the liquid interface to allow the microspheres to wet out and incorporate into the mix. Without the aid of the vacuum, the microspheres would continually kick up into the head space and float around causing extremely long mix times, excessive shear and elevated temperatures in the mix due to excessive shear that could compromise the latex stability. The vessel cannot be opened to add remaining materials until the head space is clear due to the floating characteristic of the microspheres. This microspheres cannot be poured into an open manway or open topped mixer. It must be mixed in through a closed system to avoid an extreme dust cloud that could pose other risks.

Consequently, in various embodiments a method of producing the composition may proceed as follows.

In various embodiments, the styrenated acrylic polymer, acrylate-acrylonitrile copolymer, and diluent are added into a vessel (block 202). Thus, in various instances, Acronal V 278, Ligos C 9504, and/or water are dosed into the vessel.

In various embodiments, a mixing apparatus (such as mixer sweep blades and/or disperser) is turned on (block 204).

Subsequently, and while the mixing apparatus is running, a secondary dispersant, defoamer, surfactant, biocide(s), freeze/thaw additive, adhesion promoter/coupling agent, and/or dispersant are introduced to the vessel (block 206). Thus, in various instances, while the mixing apparatus is running, KTPP, Foamstar 2420, Zetasperse 179, Polyphase 678, Mergal 758, monopropylene glycol, Silquest A-186, and/or Tamol 851 are added. In various instances, one or more of the secondary dispersant, defoamer, surfactant, biocide(s), freeze/thaw additive, adhesion promoter/coupling agent, and/or dispersant may be added through an open port of the vessel, though other introduction means are contemplated.

In various embodiments, a first delay follows block 206 to facilitating the mixing in of the previously added ingredients (block 208). For example, in various embodiments, the mixing apparatus continues to run for a first duration of time following the addition of the secondary dispersant, defoamer, surfactant, biocide(s), freeze/thaw additive, adhesion promoter/coupling agent, and/or dispersant. In various instances, the first duration of time may be about 10 minutes, though other durations may be contemplated.

Subsequently to the first delay, the mixing apparatus may be stopped (block 210). For instance, the mixing apparatus (such as mixer sweep blades and/or disperser) may be stopped.

While the mixing apparatus is stopped, the method may contemplate adding the microspheres (block 212). For instance, a microsphere, such as the Expancel® microsphere discussed previously, may be added. Subsequently, a second delay may follow block 212 wherein the mixing apparatus remains stopped until the head space of the vessel substantially clears of floating microspheres (block 214). In various embodiments, the second delay may be approximately 5 to 20 minutes depending on the dimensions of the mixer, type of mixing apparatus (such as disperser and/or mixer blades), batch size and the volume amount of Expancel®.

Subsequently, and in various embodiments, a vacuum pump may be activated to achieve a vacuum in the vessel (block 216). In various embodiments, the vacuum maybe about 25 in Hg (about 635 mm Hg) of vacuum. In various embodiments, the vacuum may be greater than about 25 in Hg (about 635 mm Hg) of vacuum.

In various embodiments, the mixing apparatus may be activated while under the vacuum (block 218). For instance, the mixing apparatus may be turned on while still under an about 25 in Hg (about 635 mm Hg) vacuum. The mixing apparatus may be turned on while still under a greater than about 25 in Hg (about 635 mm Hg) vacuum. The mixing apparatus may be operated until substantially all the microspheres are mixed in. The substantially all microspheres may be mixed in when a liquid layer is visible, though other indicia maybe contemplated.

In various embodiments, the vacuum is subsequently released. (block 220). While the mixing apparatus continues in an activated state, further ingredients may be added. For example, a functional filler, kaolin clay, and/or a pH modifier may be added (block 222). In various embodiments, titanium dioxide, ASP-170 and/or aluminum hydroxide added.

Subsequently, the vacuum pump may be activated to achieve a vacuum in the vessel (block 224). In various embodiments, the vacuum may be about 25 in Hg (about 635 mm Hg) of vacuum. In various embodiments, the vacuum may be greater than about 25 in Hg (about 635 mm Hg) of vacuum.

In various embodiments, the mixing apparatus may be activated and/or may remain activated while under the vacuum (block 226). For instance, the mixing apparatus may be turned on or may remain turned on while still under about 25 in Hg (about 635 mm Hg) vacuum. In various embodiments, the mixing apparatus may be turned on or may remain turned on while still under greater than about 25 in Hg (about 635 mm Hg) of vacuum. The mixing apparatus may be operated until the composition is substantially homogeneous. In various embodiments, the mixing apparatus may be activated for approximately 15 minutes to achieve substantial homogeneity, though other durations may be contemplated.

In various embodiments, the vacuum is subsequently released (block 228). The mixing apparatus remains active and an ASE thickener is added (block 230). In various embodiments, the ASE thickener may be P1172.

Subsequently the mixing apparatus may be operated for a third delay period (block 232). In various embodiments, the third delay comprises about one minute, though different durations may be contemplated.

The method may also include adding a pH modifier (block 234). For example, in various instances, ammonium hydroxide may be added.

Subsequently, the vacuum pump may be activated to achieve a vacuum in the vessel (block 236). In various embodiments, the vacuum may be about 25 in Hg (about 635 mm Hg) of vacuum. In various embodiments, the vacuum may be greater than about 25 in Hg (about 635 mm Hg) of vacuum.

In various embodiments, the mixing apparatus may remain activated or may be activated while under the vacuum (block 238). For instance, the mixing apparatus may be turned on while under an about 25 in Hg (about 635 mm Hg) vacuum. The mixing apparatus may be turned on while under a greater than about 25 in Hg (about 635 mm Hg) vacuum. The mixing apparatus may be operated until the ASE thickener (e.g., ammonium hydroxide) is adequately mixed. In various embodiments the mixing apparatus may remain activated for a fourth delay period (block 240). In various instances, the fourth delay is approximately 15 minutes, though other durations may be contemplated.

Finally, the mixing apparatus may be stopped and vacuum may be released (block 242).

It should be appreciated that the above method is an example, and may be modified to achieve different performance parameters. Such modifications may be made to the order in which the materials are added, specific chemical additives used, timing related to opening and closing the mixer, use of the vacuum, and timing of the mixing apparatus and different aspects of the mixing apparatus.

In some embodiments, the disclosed composition may be packaged using a filtering process to remove any particles or agglomerates that could clog spray apparatus nozzles. In one embodiment, for example, after the finished product is mixed, it is drawn through a sieve with a vacuum pump. Another embodiment for filtering particles or agglomerates that could clog spray apparatus nozzles includes using a continuous filtering system with internal sweeps that remove the particles or agglomerates from the screen continuously and can be purged regularly as needed to allow the incoming filter pressure to remain close to the outgoing filter pressure. In various embodiments, after the finished product is mixed, it is filtered through a sieve of a self-cleaning industrial filter system. The disclosed filtering processes offer an improvement over other filtering methods, such as using a sock filter, which becomes quickly backed up with finished product due to the compressible nature of the composition which will quickly stop the product from flowing through by deforming and compacting the microspheres inside the sock, which will build pressure until the sock is breached.

A number of additional and alternative embodiments of the present disclosure may be provided without departing from the spirit or scope of the present disclosure as set forth in the aspects provided herein. These various embodiments are believed to be understood by one of ordinary skill in the art in view of the present disclosure.

1. An elastomeric mastic sealant composition comprising:
between about 13 and about 19 weight percent or between about 11 and about 15 volume percent of acrylate-acrylonitrile copolymer;
between about 36 and about 41 weight percent or between about 29 and about 34 volume percent of styrenated acrylic polymer;
between about 1 and about 2 weight percent or between about 0.9 and about 1.7 volume percent of surfactant;
between about 0.6 and about 1.4 weight percent or between about 0.4 and about 1 volume percent of dispersant; and
between about 0.4 and about 1 weight percent or between about 29 and about 40 volume percent of pre-expanded compressible microspheres having an organic outer surface and introduced by a closed mixing system into the copolymer.

2. The elastomeric mastic sealant composition of claim 1, wherein the sealant composition has a density of about 0.82 g/cm³.

3. The elastomeric mastic sealant composition according to claim 1, wherein the microspheres are selected from a group consisting of: Expancel MI 90 DET 80 d15 microspheres and Expancel 909 DET 80 d15 microspheres.

4. The elastomeric mastic sealant composition of claim 1 further comprising:
between about 3 and about 12 weight percent or between about 3 and about 10 volume percent of diluent;
between about 0.04 and about 0.3 weight percent or between about 0.04 and about 0.3 volume percent of defoamer;
between about 0.04 and about 0.5 weight percent or between about 0.03 and about 0.4 volume percent of a first biocide;
between about 0.7 and about 1.5 weight percent or between about 0.6 and about 1.2 volume percent of a freeze/thaw additive;
between about 0.7 and about 4 weight percent or between about 0.5 and about 3.2 volume percent of a thickener;
between about 0.3 and about 1.1 weight percent or between about 0.2 and about 1 volume percent of a pH modifier; and
between about 21 and about 26 weight percent or between about 7.3 and about 9.4 volume percent of a first flame retardant.

5. The elastomeric mastic sealant composition of claim 4, further comprising at least between about 0.04 and about 0.5 weight percent or between about 0.03 and about 0.4 volume percent of a second biocide.

6. The elastomeric mastic sealant composition of claim 5, further comprising:
between about 0 and about 2 weight percent or between about 0 and about 0.5 volume percent of functional filler;
between about 2 and about 5 weight percent or between about 0.6 and about 1.7 volume percent of kaolin clay;
between about 0.07 and about 0.3 weight percent or between about 0.09 and about 0.2 volume percent of adhesion promoter.

7. The elastomeric mastic sealant composition of claim 1, wherein the pre-expanded compressible microspheres are introduced into the acrylate-acrylonitrile copolymer.

8. The elastomeric mastic sealant composition of claim 1, wherein the pre-expanded compressible microspheres are introduced into the acrylate-acrylonitrile copolymer utilizing a vacuum to facilitate wetting out the microspheres.

9. The elastomeric mastic sealant composition of claim 1, wherein the pre-expanded compressible microspheres are introduced by a peristaltic pump of the closed mixing system into the acrylate-acrylonitrile copolymer.

10. The elastomeric mastic sealant composition of claim 1,
wherein an aqueous uncured state of the sealant composition has a first aqueous volume and is capable of being compressed from the first aqueous volume to a second aqueous volume that is less than the first aqueous volume.

11. A method of manufacturing a sealant composition, the method comprising:
mixing a liquid and additives in a vessel including a mixing apparatus;
activating the mixing apparatus of the vessel to stir the liquid and additives;
activating a vacuum configured to draw a polymeric dispersion into the vessel;
dosing a polymeric dispersion into the mix of liquid and additives;
dosing a density modifier comprising microspheres into the vessel via a peristaltic pump,
wherein the sealant composition comprises between about 29 and about 40 volume percent of the density modifier;
permitting the density modifier to settle onto the polymeric dispersion to clear the density modifier from a headspace of the vessel; and
activating the vacuum and activating the mixing apparatus to wet out the density modifier; and
deactivating the vacuum and deactivating the mixing apparatus.

12. The method of claim 11, further comprising:
adding a first dry material following the deactivating the mixing apparatus; and
reactivating the mixing apparatus to stir the liquid, additives, density modifier, and first dry material.

13. The method of claim 11,
wherein a cured state of the sealant composition is a closed-cell air barrier thermally insulating foam and has a first cured volume and is compressible from the first cured volume to a second cured volume when under a pressure,
wherein the cured state of the sealant composition is configured to return to the first cured volume after the pressure is removed, and
wherein an aqueous uncured state of the sealant composition has a first aqueous volume and is capable of being compressed from the first aqueous volume to a second aqueous volume that is less than the first aqueous volume.

14. The method of claim 11, further comprising filtering the sealant composition for use in a spray application.

15. The method of claim 14, wherein filtering the sealant composition comprises drawing the sealant composition through a sieve with a vacuum pump.

16. The method of claim 14, wherein the filtering the sealant composition comprises continuously sweeping the sealant composition through a sieve of a self-cleaning industrial filter system.

17. The method of claim 11, wherein the density modifier includes microspheres comprising an outer shell encapsulating a gas.

18. The method of claim 11, further comprising packaging the sealant composition in one or more of aerosol cans, cartridge tubes, bulk caulking guns, foil tubes, squeeze tubes, buckets, or combinations thereof.

19. The method of claim 11, wherein the elastomeric mastic sealant composition is configured to have one or more of the attributes selected from a group consisting of: air blocking, structural reinforcement, moisture resistance, condensation control, thermal resistance, smoke resistance, flame resistance, reduced shrinkage, altered density, changed electro-conductivity, improved scrub resistance, reduced tack, altered optical properties, altered permeability, vibration dampening, acoustical absorption, slump resistance, stain resistance, low temperature flexibility, extension and recover, insulating, low density, easy extrudability, easy tooling, and easy to spray apply.

20. The method of claim 11, wherein the one or more additives are selected from the group consisting of mica, aluminum trihydrate (ATH), magnesium hydroxide, expandable graphite, ammonium polyphosphate, ammonium phosphate, urea, sodium silicate, and combinations thereof.

21. The method of claim 11, wherein the sealant composition comprises between about 29 and about 40 volume percent of the density modifier, or
wherein the sealant composition comprises about 33.4 volume percent of the density modifier.

22. A method of manufacturing a sealant composition, the method comprising:
adding styrenated acrylic polymer, acrylate-acrylonitrile copolymer, and diluent into a vessel;
activating a mixing apparatus;
while the mixing apparatus is activated, adding a secondary dispersant, defoamer, surfactant, biocide, freeze/thaw additive, adhesion promoter/coupling agent, and dispersant to the vessel to form at least a portion of a composition;
causing the mixing apparatus to continue running for a first delay period;
stopping the mixing apparatus and while the mixing apparatus is stopped, adding microspheres to the vessel;
causing the mixing apparatus to remain stopped for a second delay period, then activating a vacuum pump to achieve a vacuum in the vessel;
activating the mixing apparatus while the vessel remains under the vacuum to mix substantially all of the microspheres into the composition, then releasing the vacuum;
after the releasing the vacuum, adding at least one of a functional filler, kaolin clay, and pH modifier while the mixing apparatus remains activated, then activating the vacuum pump to achieve the vacuum in the vessel containing the at least one of the functional filler, kaolin clay, and pH modifier;
causing the mixing apparatus to mix until the composition is substantially homogeneous, then releasing the vacuum while the mixing apparatus remains activated;
adding an ASE thickener while the mixing apparatus remains activated;
causing the mixing apparatus to continue running for a third delay period;
following the third delay period, adding a pH modifier to the vessel and activating the vacuum pump to achieve the vacuum in the vessel while the mixing apparatus remains activated;
causing the mixing apparatus to continue running for a fourth delay period; and
following the fourth delay period, deactivating the mixing apparatus and releasing the vacuum, wherein the composition in the vessel comprises the sealant composition.
